SEQUENCE LISTING (30 sequences)

SEQ ID NO: 1 - protein, 5 aa, Artificial
  Linker Sequence
  misc_feature (5)..(5): Xaa can be any naturally occurring amino acid
GGGSX

SEQ ID NO: 2 - protein, 11 aa, Artificial Sequence
  Linker Sequence
AAAGSGGASAS

SEQ ID NO: 3 - protein, 16 aa, Artificial Sequence
  Linker sequence
  misc_feature (8)..(8): Xaa can be any naturally occurring amino acid
AAAGSGGXGGGGASAS

SEQ ID NO: 4 - protein, 18 aa, Artificial Sequence
  Linker Sequence
  misc_feature (8)..(8): Xaa can be any naturally occurring amino acid
  misc_feature (12)..(12): Xaa can be any naturally occurring amino acid
AAAGSGGXGGGXGGASAS

SEQ ID NO: 5 - protein, 21 aa, Artificial Sequence
  Linker Sequence
  misc_feature (8)..(8): Xaa can be any naturally occurring amino acid
  misc_feature (13)..(13): Xaa can be any naturally occurring amino acid
AAAGSGGXGGGGXGGGGASAS

SEQ ID NO: 6 - protein, 26 aa, Artificial Sequence
  Linker Sequence
  misc_feature (8)..(8): Xaa can be any naturally occurring amino acid
  misc_feature (13)..(13): Xaa can be any naturally occurring amino acid
  misc_feature (18)..(18): Xaa can be any naturally occurring amino acid
AAAGSGGXGGGGXGGGGXGGGGASAS

SEQ ID NO: 7 - protein, 31 aa, Artificial Sequence
  Linker Sequence
  misc_feature (8)..(8): Xaa can be any naturally occurring amino acid
  misc_feature (13)..(13): Xaa can be any naturally occurring amino acid
  misc_feature (18)..(18): Xaa can be any naturally occurring amino acid
  misc_feature (23)..(23): Xaa can be any naturally occurring amino acid
AAAGSGGXGGGGXGGGGXGGGGXGGGGASAS

SEQ ID NO: 8 - protein, 36 aa, Artificial Sequence
  Linker Sequence
  misc_feature (8)..(8): Xaa can be any naturally occurring amino acid
  misc_feature (13)..(13): Xaa can be any naturally occurring amino acid
  misc_feature (18)..(18): Xaa can be any naturally occurring amino acid
  misc_feature (23)..(23): Xaa can be any naturally occurring amino acid
  misc_feature (28)..(28): Xaa can be any naturally occurring amino acid
AAAGSGGXGGGGXGGGGXGGGGXGGGGXGGGGASAS

SEQ ID NO: 9 - protein, 41 aa, Artificial Sequence
  Linker Sequence
GASASEAPQNSGAPETNTEPAGSNQPAEDIAAAGSGGASAS

SEQ ID NO: 10 - protein, 46 aa, Artificial Sequence
  Linker Sequence
  misc_feature (38)..(38): Xaa can be any naturally occurring amino acid
GASASEAPQNSGAPETNTEPAGSNQPAEDIAAAGSGGXGGGGASAS

SEQ ID NO: 11 - protein, 48 aa, Artificial Sequence
  Linker Sequence
  misc_feature (38)..(38): Xaa can be any naturally occurring amino acid
  misc_feature (42)..(42): Xaa can be any naturally occurring amino acid
GASASEAPQNSGAPETNTEPAGSNQPAEDIAAAGSGGXGGGXGGASAS

SEQ ID NO: 12 - protein, 51 aa, Artificial Sequence
  Linker Sequence
  misc_feature (38)..(38): Xaa can be any naturally occurring amino acid
  misc_feature (43)..(43): Xaa can be any naturally occurring amino acid
GASASEAPQNSGAPETNTEPAGSNQPAEDIAAAGSGGXGGGGXGGGGASAS

SEQ ID NO: 13 - protein, 56 aa, Artificial Sequence
  Linker Sequence
  misc_feature (38)..(38): Xaa can be any naturally occurring amino acid
  misc_feature (43)..(43): Xaa can be any naturally occurring amino acid
  misc_feature (48)..(48): Xaa can be any naturally occurring amino acid
GASASEAPQNSGAPETNTEPAGSNQPAEDIAAAGSGGXGGGGXGGGGXGGGGASAS

SEQ ID NO: 14 - protein, 61 aa, Artificial Sequence
  Linker Sequence
  misc_feature (38)..(38): Xaa can be any naturally occurring amino acid
  misc_feature (43)..(43): Xaa can be any naturally occurring amino acid
  misc_feature (48)..(48): Xaa can be any naturally occurring amino acid
  misc_feature (53)..(53): Xaa can be any naturally occurring amino acid
GASASEAPQNSGAPETNTEPAGSNQPAEDIAAAGSGGXGGGGXGGGGXGGGGXGGGGASAS

SEQ ID NO: 15 - protein, 66 aa, Artificial Sequence
  Linker Sequence
  misc_feature (38)..(38): Xaa can be any naturally occurring amino acid
  misc_feature (43)..(43): Xaa can be any naturally occurring amino acid
  misc_feature (48)..(48): Xaa can be any naturally occurring amino acid
  misc_feature (53)..(53): Xaa can be any naturally occurring amino acid
  misc_feature (58)..(58): Xaa can be any naturally occurring amino acid
GASASEAPQNSGAPETNTEPAGSNQPAEDIAAAGSGGXGGGGXGGGGXGGGGXGGGGXGGGGASAS

SEQ ID NO: 16 - protein, 18 aa, Artificial Sequence
  Amino acid inker
GSSSGSDGKASGGSASGG

SEQ ID NO: 17 - protein, 16 aa, Artificial Sequence
  Amino acid linker
AAAGSGDGGGSGASAS

SEQ ID NO: 18 - protein, 16 aa, Artificial Sequence
  Amino acid linker
AAAGSGNGGGSGASAS

SEQ ID NO: 19 - protein, 16 aa, Artificial Sequence
  Amino acid linker
AAAGSGGGGGSGASAS

SEQ ID NO: 20 - protein, 16 aa, Artificial Sequence
  Amino acid linker
AAAGSGVGGGSGASAS

SEQ ID NO: 21 - protein, 18 aa, Artificial Sequence
  Amino acid linker
AAAGSGDGGGSYGGASAS

SEQ ID NO: 22 - protein, 18 aa, Artificial Sequence
  Amino acid linker
AAAGSGAGGGSWGGASAS

SEQ ID NO: 23 - protein, 18 aa, Artificial Sequence
  Amino acid linker
AAAGSGGGGGSVGGASAS

SEQ ID NO: 24 - protein, 18 aa, Artificial Sequence
  Amino acid linker
AAAGSGSGGGSLGGASAS

SEQ ID NO: 25 - protein, 18 aa, Artificial Sequence
  Amino acid linker
AAAGSGGGGGSKGGASAS

SEQ ID NO: 26 - protein, 21 aa, Artificial Sequence
  Amino acid linker
AAAGSGLGGGSEGGGSGASAS

SEQ ID NO: 27 - protein, 21 aa, Artificial Sequence
  Amino acid linker
AAAGSGGGGGSRGGGSGASAS

SEQ ID NO: 28 - protein, 21 aa, Artificial Sequence
  Amino acid linker
AAAGSGVGGGSQGGGSGASAS

SEQ ID NO: 29 - protein, 21 aa, Artificial Sequence
  Amino acid linker
AAAGSGAGGGSSGGGSGASAS

SEQ ID NO: 30 - protein, 21 aa, Artificial Sequence
  Amino acid linker
AAAGSGNGGGSVGGGSGASAS

(19) United States
(12) Patent Application Publication
(10) Pub. No.: US 2007/0042399 A1
(43) Pub. Date: Feb. 22, 2007

(54) BIOLOGICAL MATERIALS AND USES THEREOF

(75) Inventors: Michael John Wright, Slough (GB); Mahendra Persaud Deonarain, Wallington (GB)

Correspondence Address: PATREA L. PABST;PABST PATENT GROUP LLP, 400 COLONY SQUARE, SUITE 1200, 1201 PEACHTREE STREET, ATLANTA, GA, 30361, US

(73) Assignee: Imperial College Innovations Limited

(21) Appl. No.: 11/426,265

(22) Filed: Jun. 23, 2006

Related U.S. Application Data
(60) Provisional application No. 60/693,282, filed on Jun. 23, 2005.

(51) Int. Cl. C40B 30/06; C40B 40/10

(52) U.S. Cl. 435/6; 435/7.1

(57) ABSTRACT

The invention relates to a library, methods of making a library of biologically active molecules and uses thereof. The library comprises a plurality of chelating ligand pairs, each said ligand pair including two ligands that bind specifically to distinct epitopes on the same target molecule and the two ligands of each ligand pair being joined by a linker, wherein the members of the library comprise linkers of variable length and variable amino acid composition.

### CROSS-REFERENCE TO RELATED APPLICATIONS

This application claims benefit of U.S. Provisional Application No. 60/693,282, entitled “Biological Materials and Uses Thereof”, to Michael John Wright and Mahendra Persaud Deonarian, filed Jun. 23, 2005.

### FIELD OF THE INVENTION

The invention relates to ligand constructs exhibiting high affinity binding and targeting of molecules, methods of making such constructs, selection of ligand constructs having desirable properties and their uses.

### BACKGROUND OF THE INVENTION

Binding to a target molecule with high affinity and high specificity is paramount in a wide range of processes, applications and therapies. For example, high affinity binding of a blood metabolite can lead to very sensitive detection and diagnostic systems for disease [Wagner P D, Maruvada P & Srivastava S (2004) Expert Rev Mol Diagn. 4, 503-11]. In addition to this, a high level of specificity will lead to clearer results with fewer false positives.

In biotechological processes, a high affinity ligand, immobilised appropriately is very useful in separating or purifying biomolecules with subtly different species being purified based on ever more specific ligands [Burgess R R & Thompson N E (2022) Curr Opin Biotechnol. 13, 304-8y].

Potentially the biggest application for high affinity and specificity is in the clinical treatment of diseases [Harris M (2004) Lancet Oncol. 5, 292-302; Milenic (2004) Nat Rev Drug Discov. 3, 488-99; Trikha (2003) Clin Cancer Res. 9, 4653-65; Vartanian (2004) Neurology 63. 42-49; Kirman (2004) Eur. J Gastroenterol Hepatol. 16, 639-41; Burton D R. (2002) Nat Rev Immunol. 2, 706-13; Ferrantelli R & Ruprecht R M (2002) Curr Opin Immunol. 14, 495-502]. Current treatment of disease is predominantly non-targeted. Drugs are administered systemically or orally which expose many other tissues as well as the tissues which are diseased.

In cancer therapy, chemotherapeutic drugs are specific for cells which are growing and dividing rapidly as they work mainly by a mechanism which interferes with DNA replication. Other cells can take up the drug and also become intoxicated, such as rapidly dividing bone marrow stem cells. This results in immuno-suppression and sickness [MM (2002) Annu. Rev. Med. 53, 615-627].

In infectious diseases, the anti-bacterial drug is introduced into the blood (orally or by injection) and interferes with a particular bacterial metabolic pathway. However, its exposure to other tissues can result in side effects. Virally-infected cells are difficult to treat as their metabolism is practically identical to uninfected human cells.

It is widely acknowledged that one aspect of the future of medicine is in the tailoring of drugs to the disease. This means delivering the therapeutic to the correct target tissue or organism, rather the non-selective hit and miss approach of many of the conventional drugs used today. This will result in lower doses administered, lower side effects and toxicities and overall better responses. Advances in genomics will one day mean that drugs can be tailored to the individual [Lengauer (2005) Nat Rev Drug Discov. 4, 375-80].

There are many drugs used clinically today that are very good at destroying or treating the diseased cells, once it has accumulated in the correct tissue. Therefore the problem is with the specific targeting of drugs rather than the effector mechanism. Examples of this include targeted ionising radiation [Milenic] as opposed to external bean radiotherapy, targeted chemotherapy drugs [Trail (2003) Cancer Immunol Immunother. 52, 328-37] (e.g. methotrexate or dixorubiein) as opposed to free drugs, immuno-toxins [Kreitman R J (2004) Expert Oplin Boiol Therm. 4, 1115-28] and targeted photodynamic therapy [Sharman (2004) Adv Drug Deliv Rev. 56, 53-76].

The ability of a specific ligand to bind to a target with very high affinity and increased specificity could lead to improved diagnostics and detection, improved processes and more effective clinical treatment for a range of diseases.

Antibodies represent a characteristic ligand found in living organisms. Antibodies have evolved to act as the first line of defence in the mammalian immune system. They are complex glycoproteins which have a high level of diversity. This diversity is derived from programmed gene shuffling and targeted mutagensis, resulting in probably a trillion different antibody sequences [Herman N. Eisen (2002) Annu Rev. of Immunol. 19, 1-21].

The diversity of antibodies means that antibodies can bind to practically many target molecule which is usually protein in nature. It is now possible to mimic antibody selection and production in vitro, selecting for recombinant human antibodies against virtually any desired target [Winter (1994) Annu Rev Immunol. 12, 433-55].

A significant number of biotechnological drugs in development are based on antibody targeting. The most popular in vitro selection technique is antibody phage display, where antibodies are displayed and manipulated on the surface of viruses. There are many therapeutic antibodies being developed for a range of diseases, primarily cancer [Harris].

Taking antibodies as an example of an ligand that is capable of binding a specific target, antibodies can bind with a variable degree of specificity to target cells expressing the appropriate receptor or other soluble targets. Binding specificity can be difficult to quantify and is a more relative term, differing in each antibody-antigen situation.

A more quantitative and measurable parameter is affinity. The affinity of an antibody is a measure of how well an antibody binds to the target (antigen). It is usually descried by an equilibrium dissociation constant (K_{d}, units M⁻¹) or equilibrium association constant (Kₐ, units M).

The affinity constant is a function of the two kinetic rate constants, kₒₙ and k_{off}. The rate of association with the antigen is dependent upon the kₒₙ rate constant (units M⁻s⁻¹) and the rate of dissociation is dependent on the k_{off} rate constant (units s⁻¹).

Technology exists to select and manipulate antibodies which have desired kinetic binding properties [Boder (2000) Proc Natl Acad Sci USA 97, 10701-5]. For antibodies that need to be internalised to deliver a cytotoxic drug, the association rate is more important as the dissociation rate does not function if the antibody is taken into the cell [Lillo (2004) Chem Biol. 11, 897-906]. For example, for antibodies which neutralize cytokines [Kawade (2003) J Immunol Methods 278, 127-44], a rapid association rate may be more beneficial.

These issues regarding affinity apply equally to all anti-ligand-ligand pairs and it is generally accepted that affinity is related to biological response. Usually, the higher the affinity, the better the response such as targeting or neutralisation. There may be some limitations such as the antigen barrier effect [Jain (1990) Cancer Res. 50, 814-819]. In medicine, increased affinity and more specifically targeted biding can also lead to lower doses and subsequently lower costs.

As with all biological molecules, the size of the antibody affects its pharmacokinetics in vivo [Batra S K, Jain M, Wittel U A, Chauhan S C & Colcher D (2002) Curr Opin Biotechnol. 13, 603-8]. Larger molecules persist longer in the circulation due to slow clearance (large glycoproteins are cleared through specific uptake by the liver).

For whole antibodies (molecular weight 150 KDa) which recognise a cancer cell antigen in a mouse tumour xenograft model system, 30-40% can be taken up by the tumour. But because they persist longer in the circulation, it takes 1-2 days for a tumour:blood ratio of more than one to be reached. Typical tumour:blood ratios are 5-10 by about day 3.

With smaller fragments of antibodies, which have been produced by in vitro techniques and recombinant DNA technology, the clearance from the circulation is faster (molecules smaller than about 50 KDa are excreted through the kidneys, as well as the liver).

Single-chain Fvs (scFvs) (about 30 KDa) are artificial binding molecules derived from whole antibodies, but contain the minimal part required to recognise antigen [Huston (1998) Proc Natl Acad Sci USA 85, 5879-83]. In mouse xenograft systems, scFvs can deliver 1-2% of the injected dose, but with tumour:blood ratios better than 20:1 within 24 hr, with some tumour:organ ratios even better [Verhaar (1995) Int J Cancer 61, 497-501].

As scFvs have only been developed over the last 10 years, there are not many examples in late clinical trials. From clinical trials of whole antibodies, the amount actually delivered to tumours is much lower than that seen in mouse models [Epenetos (1986) Cancer Res. 46, 3183-91], but with similar tumour:organ ratios. If another molecule is attached to the antibody, then the new size determines the altered pharmacokinetic properties [Batra]. Other properties such as net charge and hydrophilicity have effects on the trageting kinetics [Pavlinkova (1999) Nucl Med Biol. 26, 27-34].

There has been considerable research into targetable therapeutic drugs where novel effector functions have been linked to antibodies or other targeting ligands. Some of these require internalisation in order to successfully deliver a toxic agent. Many of these have shown good results in vitro and in vivo in animal models, but have been disappointing in the clinic.

Immunotoxins have shown problems such as immune reactions and liver/kidney toxicity. There have been developments with new ‘humanised’ immunotoxins based on enzymes such as ribonuclease [Deonarain (1998) Br. J. Cancer 77,537-46] and deoxyribonuclease [Linardou (2000) Int. Cancer 86, 561-9]. These potentially have lower side effects are more tolerable, but still do not have a bystander killing effect.

Chemotherapy drugs tend to be much less active when linked to proteins [Trail] as they do not get released effectively and radioimmunotherapy [4] tends to irradiate other tissues en route to the tumour, giving bone marrow and liver toxicity.

Photosensitising (PS) drugs are attractive agents to link to proteins as the cytotoxic elements are the singlet oxygen species generated from them and not the PS drugs themselves [van Dongen (2004) Adv Drug Deliv Rev. 56, 31-52]. It is widely accepted that antibodies or proteins derived from humans are better for clinical applications due to lower risk of imunogenicity and toxic side effects [Harris].

Although antibodies are the first choice when it comes to considering ligands for targeting or detection, there exist many alternative ligands, some of which have been exploited through phage (or other) display/selection techniques. These include natural ligands for receptors (e.g. interleukin-6 (IL-6) [Ancey (2003) J. Bio.l Chem. 278, 16968-72] and tissue necrosis factor (TNF) [Borsi (2003) Blood. 102, 4384-92], peptides (e.g. neuropeptides [Korner (2005) Int J Cancer 115, 734-41]) immunoglobulin-like domains (such as fibronectin (fn3) domains [Koide (1998) J Mol Biol. 284, 1141-51], single immunoglobulin domains [Holt (2003) Trends Biotechnol. 21, 484-901]), anticalins [Schleuhuber (2002) Biol Chem. 382, 1335-41], ankyrin repeats [Binz H K, Amstutz P, Kohl A, Stumpp M T, Briand C. Forrer P, Grutter M G & Pluckthun A (2004) Nat Biotechnol. 22, 575-82], etc.

TABLE 1
List of antibody and non-antibody based ligands used in phage
display which could be used in the chelating ligand technology

| Type | Ligand name | Reference |
|---|---|---|
| Immunoglobin-based | Domain | Holt (2003) Trends Biotechnol. |
| | antibodies | 21, 484-90 |
| | Single chain | Winter (1994) Annu Rev |
| | Fvs | Immunol. 12, 433-55 |
| | Fab fragment | Hoogenboom (1991) Nucleic |
| | | Acids Res. 19, 4133-7 |
| | Fn3 domains | Koide (1998) J Mol Biol. 284, |
| | | 1141-51 |
| | Protein L | Enever (2005) J. Mol. Biol. |
| | | 347, 107-20 |
| | T cell | Li (2005) Nat. Biotechnol. 23, |
| | receptors | 349-54 |
| Non-immunoglobin | Peptides | Pini (2004) Curr. Protein Pept. |
| | | Sci. 5, 487-96 |
| | Ankyrin | Binz (2004) Nat Biotechnol. 22, |
| | repeats | 575-82 |
| | Anticalin | Schlehuber (2001) Biol Chem. |
| | | 382, 1335-42 |
| | Pou domains | Phillips (2000) J. Mol. Biol. |
| | | 302, 1023-39 |
| | Various | Fernandez-Gacio (2003) Trends |
| | enzymes | Biotechnol. 21, 408-14: Heinis |
| | | (2004) Biochemistry 25, 6293-303 |

Chelating recombinant antibodies (CRAbs) comprise linked pairs of scFv molecules characterised in that each scFv binds a distinct non-overlapping target epitope on the same target molecule. These two scFv molecules therefore chelate by binding two distinct epitopes on the same target.

The chelate effect with respect to binding is the use of two (or more), non-overlapping ligands which are covalently linked, to bind the same target molecule (FIG. 1). The simultaneous binding at two distinct sites results in a combined affinity which is significantly greater than the binding of the individual components alone.

The binding of one ligand increases the likelihood of the other ligand binding (co-operative binding). This approach can provide a high affinity interaction by simply linking two medium or low affinity binding molecules. The implications are not only higher affinities (picomolar or better), but also high affinity independent of antigen density on a surface (e.g. a cell) or in solution (e.g. a cytokine or metabolite). This may be of significance if, for example the target antigen is present at very low concentration on the cell surface or in solution.

Conventional bivalent binding species such as immunoglobulins or F(ab)₂s rely on antigen cross-linking to achieve higher affinity (avidity effect). This cross linking of two antigen molecules can occur if the antigen is immobilised in some way or present at a high enough density on a cell surface. Antigens which are expressed on the surface of a cell at low density or antigens in solution tend to be bound with lower affinities as antigen cross-linking is absent or rare.

The chelate effect has been exploited in nature to derive high affinity binding from lower affinity components. Metal ions are tightly co-ordinated in proteins using multiple ligands such as cysteine thiols [Klug A (2005) FEBS Lett. 579, 892-4]. The hirundin protein binds to thrombin acting as a very effective inhibitor. It achieves this by binding with two linked domains, optimally spaced [van de Locht (1995) EMBO J. 14, 5149-57]. Neri et al. [Neri (1996) J Mol Biol. 246, 367-73] showed that recombinant antibodies can mimic this chelate effect using a model antigen (lysozyme). Using the X-ray crystal structures of the complexes for each of the two scFvs with lysozyme, Neri et al were able to create a model of both antibodies bound to lysozyme and identify a linker suitable to construct a recombinant biparatopic single-chain Fv (scFv). The resulting increase in affinity was some 20-100-fold.

Other groups have followed nature's example and linked two binding domains with different length linkers to increase affinity and inhibition potency [Ancey]. Zhou has produced a mathematical model based on the worm-like chain model, to derive the theoretical affinity for CRAb-like antibodies, based on the known liner length and the individual affinities [Zhou HX (2003) J. Mol. Biol. 329, 1-8]. Overall, the key feature of chelating ligands (such as antibodies) is that the linker sequence and length must be optimal and is usually only identifiable by structural determination of the ligand-antigen complexes.

The use of recombinant antibodies in immuno-assays or diagnostics is a well studied area [Zhou]. The high level of variation specificity, high affinity and versatility of antibodies and antibody fragments makes them ideal binding molecules as part of a detection system.

In conventional approaches, a binding event between target and antibody has itself to be detected via a secondary reagent or system often involving multiple washing and separation steps to reduce the non-specific interactions. An example of such an assay is the antibody-based ELISA (Enzyme Linked Immuno-Sorbant Assays) system (a heterogeneous system).

These multiple steps can be time-consuming and labour intensive especially for high throughput applications. Also, these procedures often include a degree of complexity rendering them unsuitable for consumer/product applications. Homogeneous assays such as EMIT, ARIS and others can avoid such washing steps but require multiple additions and incubations and rely on labelled antigen [Zhou HX (2003) J. Mol. Biol. 329, 1-8 ].

Optical biosensors can provide a homogeneous system for immuno-assays, resulting in a one-step detection system [J. R. North (1985) Trends Biotechnol. 3, 180-186]. The best example of this is the incorporation of optically-sensitive probes, such as fluoroophores in or near the antigen binding site of antibodies. This is usually achieved by covalent chemical modification through an engineered cysteine thiol group [Renard (2003) J. Mol. Biol. 326, 167-75].

When the antigen has bound the antibody, the change in environment around the fluorophore leads to a quantitative and measurable change in fluorescence. Bedouelle and co-workers have done much work in this field [Renard] and have experimentally deduced that residues suitable for mutangenesis into cysteine for thiol-probe coupling must not interact with the antigen, must be close to the antigen binding site and must have a solvent exposed thiol after muytagenesis. This sort of information is available only if a 3-D molecular structure is available of the antibody-antigen complex.

Winter and co-workers have devised a phage-display strategy [Jespers L, Bonnert T P & Winter G (2004) Protein Eng Des Sel. 17, 709-13] where a suitable antibody is selected for after the probe has been coupled to the antibody. This is in the form of a phage particle and problems with the phage reacting with the probe exist, as well as possible limitations in affinity. A general problem with the above approaches is that the introduction of an unpaired cysteine can lead to a reduction of functional antibody production [Renard], particularly if the cysteine is near one of the conserved disulphide bridges. This may be due to mis-pairing during folding.

All of these issues also apply to non-antibody based biosensors. Natural binding proteins have been engineered to recognise alternative substrates, with reporter groups placed close to the ligand binding site or in a conformationally sensitive location [Gilardi G, Zhou L Q, Hibbert L & Cass A E (1994) Anal Chem. 66, 3840-7]. The limitation of these proteins in such application is that a detailed knowledge of the protein dynamics is needed and the binding is restricted to substrates related to the natural substrate.

Hence, the main challenges in the development of optical antibody-based biosensors are: (1) the successful introduction of a reporter group close enough to the antigen binding site to report a signal, but not to compromise antigen binding affinity or specificity, (2) to generate reagents which are sensitive at low antigen concentrations (lower than picomolar concentrations) and (3) to have a system which has a large dynamic range enabling detection at low and high concentration of antigen. Improvements in affinity and novel linker technologies promise to address these challenges.

### BRIEF SUMMARY OF THE INVENTION

A method is described for selecting the optimal linker length and sequence from a library of different linkers, which allows two ligands to bind cooperatively to its target in such a way as they bind as one chelating ligand with a higher affinity than either of the two individual ligands.

The method involves creating a library of linker using PCR and cloning followed by a library selection technique such as phage display. In its simplest form, two ligands are linked with a library of linkers (randomised in terms of length and sequence), but multiple ligands can be included such as multiple pairs of ligand (multi-CRAb libraries).

This approach circumvents the time-consuming, costly and not always successful approach of determining the 3-D structures (using X-ray crystallography or NMR) of each antigen-ligand complex, followed by molecular modelling to calculate the correct linker length, followed by molecular cloning. This approach can be extended to more than two ligands with additional libraries of linkers. The ligands can be any natural or synthetic binding protein such as a recombinant antibody.

### BRIEF DESCRIPTION OF THE DRAWINGS

FIGS. 1a-e is an illustration of the principle of chelating recombinant ligands (antibodies-CRAbs).

FIGS. 2a-i is a scheme illustrating ligand linker library construction and selection where ligand is a single-chain Fv (scFv).

FIG. 3 is an illustration of a multiple CRAb (multi-CRAb) library.

FIG. 4 is an illustration demonstrating that chelating recombinant ligands (e.g. scFvs) can make effective biosensors.

FIG. 5 is an illustration demonstrating that chelating recombinant ligands can be extended to three or more ligands.

FIGS. 6a-c illustrate the construction of the ‘null CRAb’ and confirmation of lack of expression/display.

FIGS. 7a, 7b show the results of two-step PCR to incorporate linker library using standard and longer annealing sequence.

FIG. 8 is a restriction digestion of the results of screening recombinant clones from library construction to show that linkers of different and variable lengths have been incorporated.

FIGS. 9a, 9b illustrate the biotinylation and purification of lysozyme protein for selections. FIG. 9a is a picture showing the purification of biotinylated lysozyme on soft-link agarose. FIG. 9b is a picture of a streptavidin-HRPO western blot confirming that the flow through contains non-biotinylated protein and the eluted fractions contain biotinylated lysozyme.

FIGS. 10a, 10b show the output monitoring of full library selections against lysozyme showing enrichment for linkers predicted to be optimal.

FIG. 11 shows the expression and purification of a recombinant CRAB protein.

FIG. 12 is a bar graph of a competition ELISA of three anti-tetanus toxin scFvs showing that they bind non-overlapping epitopes.

FIGS. 13a, 13b illustrates the biotinylation and purification of tetanus toxin protein for selections. FIG. 13a shows the purification of biotinylated tetanus toxin heave chain on soft-link agarose. FIG. 13b is a picture of a streptavidin-HRPO western blot confirming that the flow through contains non-biotinylated protein and the eluted fractions contain biotinylated TeTxHc.

FIG. 14 is a picture of a restriction digest showing the results of output monitoring of multi-CRAb selection experiment against tetanus toxin.

FIGS. 15a, 15b and 15c show pie charts demonstrating that the anti-TeTxHc multi-CRAb library contains equal numbers of each possible pair.

### DETAILED DESCRIPTION OF THE INVENTION

In a first aspect of the invention there is provided a library comprising a plurality of chelating ligand pairs, each said ligand pair including two ligands that are capable of binding in specifically to distinct epitopes on a common target molecule and the two ligands of each ligand pair are joined by a linker, and wherein the library comprises ligand pairs having linkers of variable length and/or variable amino acid sequence. Optionally, one or more further ligands are linked to the chelating ligand pair.

Preferably the library is a display library and more preferably the library is a phage display library.

Conveniently the ligand pairs comprise a pair of antibodies or antibody fragments. Preferably the ligand pairs comprise a pair of scFv molecules.

Advantageously the distinct epitopes of the target molecule do not overlap.

Optionally, the chelating ligand pair further comprises a detectable or therapeutically active moiety and conveniently that further moiety is selected from the use of detection tags (e.g. polyhistidine, c-myc), tags for interaction with further molecules such as biotin), raidioisotopes for diagnosis and therapy (e.g., Iodine-125, Yttrium-90, Technicium-99), enzymes (e.g. drug activating enzymes-carboxypeptidase G2, beta lactamase), toxins (e.g. ricin), drugs (e.g. methotrexate and taxol), photosensitisers (e.g. foscan) and cytokines (e.g. IL-2, IL-12, IL-15).

Further optionally one or more properties of the further molecule are altered when the chelating ligand pair is bound to the target molecule.

In a second aspect of the invention there is provided a method of making a library of chelating ligand pairs as defined in the first aspect of the invention comprising the steps of:

(a) providing a plurality of first ligands;

(b) providing a plurality of second ligands, said second ligand being attached to a linker molecule, and wherein the linker molecules are of variable length and variable amino acid composition;

(c) joining a first ligand to a second ligand using the linker so as to form a plurality of chelating ligand pairs, and

(d) repeating step (c) so as to produce a library of chelating ligand pairs.

Preferably the first ligands provided in step (a) are modified to disrupt the C-terminal to prevent display of the first ligand. One possible method of disrupting the C-terminal sequence is to insert some so-called junk DNA to disrupt the structure of the C terminal sequence. This disruption prevents the ligand being displayed if the invention is being used in a display library. Preferably, the modification of the C-terminal sequence preventing display is corrected when the first ligand is joined to the second ligand.

Optionally, the method includes at least one of the following steps
(e) displaying the library of chelating ligand pairs;
(f) exposing the library to the target molecule;
(g) identifying the chelating ligand pair exhibiting the desired binding activity;
(h) isolating the chelating ligand pair exhibiting the desired binding activity;
(i) amplifying the chelating ligand pair isolated in step (h); and
(j) formulating the chelating ligand pair isolated in step (h) and/or amplified in step (i) into a pharmaceutical composition.

Preferably the desired biding activity is represented by the ligand pair exhibiting the strongest binding affinity or most appropriate specificity.

In a third aspect of the invention there is provided the use of the library of the first aspect of the invention to identify chelating ligand pairs exhibiting a desired binding activity.

There is also provided the use of the method as defined in the second aspect of the invention in identifying chelating pairs exhibiting a desired biding activity.

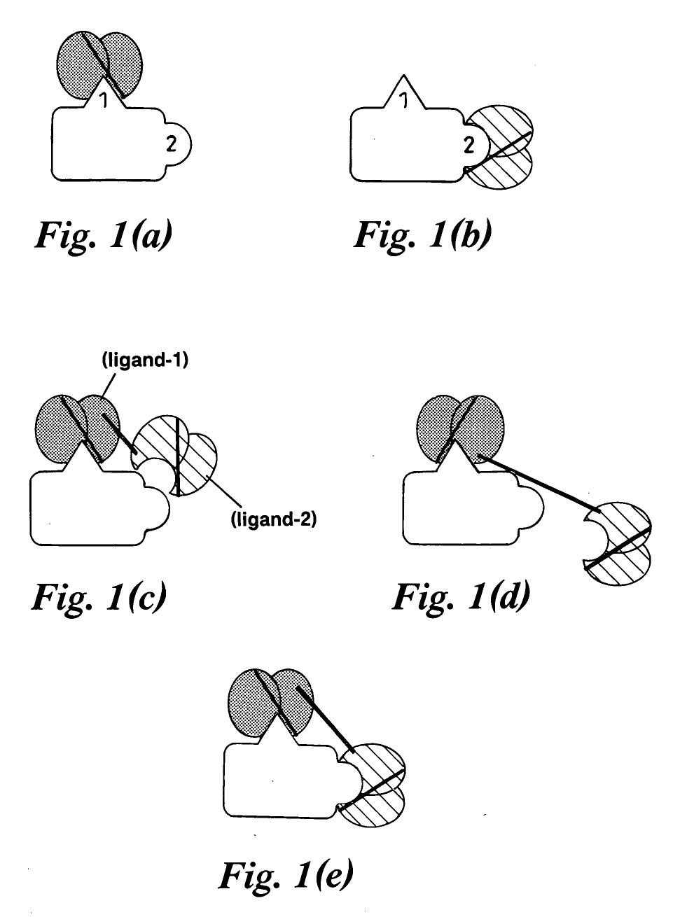

Hence this invention relates to the process or method for selecting the optimum length and sequence of an amino acid linker which connects two ligands together resulting in very high affinity. By connecting the two ligands in such a way will allow them to bind to the antigen with a higher affinity than either parental ligands due to the chelate enhancement effect. These ligands bind to two, distinct, non-overlapping eiptopes on the same antigen molecule. It is important that these ligands have the potential to bind simultaneously and that the binding of one does not alter the epitope of the other (FIG. 1) either sterically or conformationally.

One or both of the ligands are preferably antibodies which have been derived by phage display technology (such as single domain antibodies, single-chain Fvs, Fabs, diabodies, etc.), but can also be any antibody format such as F(ab)₂′s and whole immunoglobulins.

One or both of the ligands can also be non-antibody in nature such as a naturally occurring ligand for that antigen molecule, a peptide, a non-antibody displayed binding protein. Further examples of possible ligands are listed in Table 1.

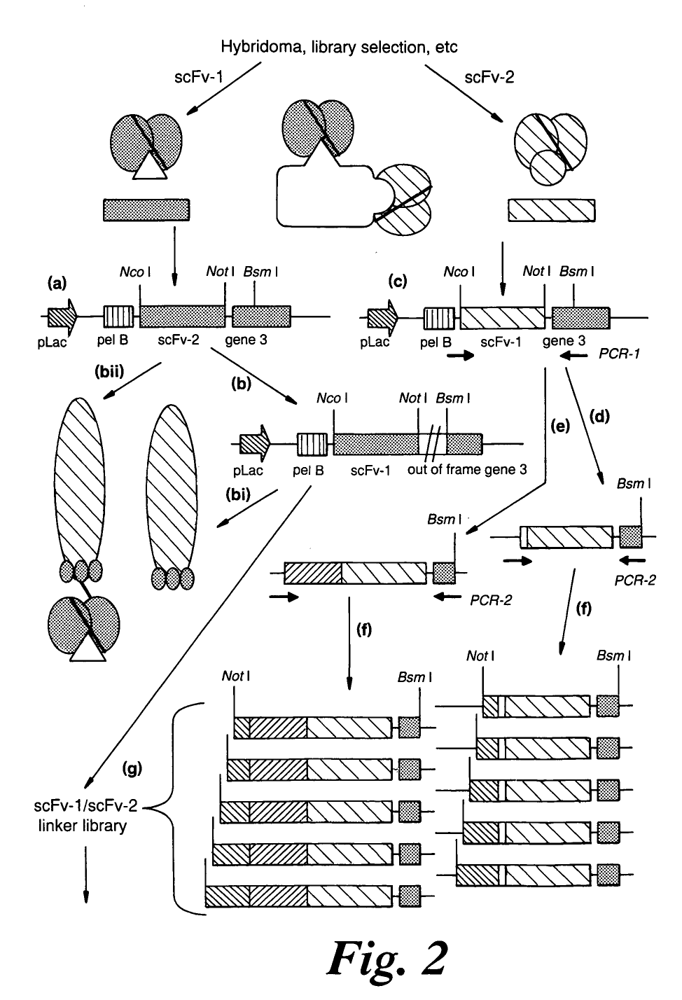

A detailed scheme of the method is shown in FIG. 2. The first ligand (destined to be the N-terminal ligand in the final fusion protein, FIG. 1a-e ) is cloned as a gene into a vector suitable for expression in E. coli and fused the gene encoding a bacteriophage coat protein such as gene 3 (minor coat protein) or gene 8 (major coat protein). This allows the ligand to be displayed on the surface of the virus and undergo phage display selection using established technology (e.g. soluble selections on paramagnetic coated beads).

The first ligand may also be cloned into a vector suitable for expression in any other heterologous or homologous expression system such as yeast, insect or mammalian cells and linked to a protein enabling it to be displayed on the surface of that organism (e.g. as in yeast surface using the Aga2p mating adhesion receptor of Saccharomyces cerevisiaei [Boder]) or bacteria surface display using the lipoprotein-outer membrane protein A system [Daugherty]). In one example, the ligand is a single chain Fv and cloned into the pHEN2 phage display vector (FIG. 2a).

The vector for the first ligand must have one or more restriction sites at the 3′ end of the ligand between the gene for the ligand and the gene for the coat protein (which allows surface display).

A DNA sequence is cloned into these restriction sites which causes the gene for the first ligand to be out of reading frame with the display coat protein. The resulting vector (called the ‘null CRAb’ or ‘null clone’ then contains the gene for the first ligand which can be expressed, but cannot be displayed (FIG. 2b). The intention is that only clones which have successfully accepted the gene for the second ligand thus restoring the reading frame with the display coat protein can be displayed and clones containing the first ligand only will not display (FIG. 2bi). Single scFv clones tend to display significantly better and interfere with the selection process (FIG. 2bii).

The second ligand is cloned into a vector such as pHEN2 (FIG. 2c). The second ligand is PCR amplified in one or more PCR amplification steps to create a set of PCR products which contain the second ligand bearing an N-terminal linker sequence of variable length (i.e. 5′ to ligand gene). The linkers used can be any length that is practical to synthesise using oligonucleotide chemistry.

They can consist of any nucleotide sequence (hence coding for any amino acid sequence). In one example, the linker is a repeating unit of ‘(Gly-Gly-Gly-Ser-X)ₙ’ (SEQ ID NO: 1) where X is any amino acid and n is any number. Glycine and serine residues are well known to provide for flexible but soluble linkers and random amino acids can help the diversity but also contribute to interactions which enhance the function of the ligands (e.g. increase the affinity further still). Linkers of smaller repeating units, non-repeating sequences or totally random amino acids can also be used.

In one example, silent site-directed mutagenesis followed by a first PCR is carried out which serves to remove any restriction sites which may interfere with subsequent cloning steps and to append a small sequence which will act as an annealing sequence for the second PCR reaction (FIG. 2d). The second PCR then adds a panel of linker lengths to the N-terminal end (5′ end of the gene) of the ligand as well as suitable restriction sites to facilitate cloning (FIG. 2e). This method is preferred as primer-1 in the first PCR is ligand-specific where as the set of linker primers can be used with any ligand as long as the annealing sequence has been incorporated by primer-1. Table 2 shows the list of possible linker sequences which might be used.

TABLE 2

List of linker sequences used in
linker library construction

| | | |
|---|---|---|
| | | Residue |
| Name | Amino acid sequence | Length |

| | | | |
|---|---|---|---|
| Standard | 0-mer | AAAGSGGASAS | 11 |
| annealing | | (SEQ ID NO: 2) | |
| primer | 1-mer | AAAGSG(GXGGG)₁GASAS | 16 |
| | | (SEQ ID NO: 3) | |
| | 1.5-mer | AAAGSG(GXGGG)₁XGGASAS | 18 |
| | | (SEQ ID NO: 4) | |
| | 2-mer | AAAGSG(GXGGG)₂GASAS | 21 |
| | | (SEQ ID NO: 5) | |
| | 3-mer | AAAGSG(GXGGG)₃GASAS | 26 |
| | | (SEQ ID NO: 6) | |
| | 4-mer | AAAGSG(GXGGG)₄GASAS | 31 |
| | | (SEQ ID NO: 7) | |
| | 5-mer | AAAGSG(GXGGG)₅GASAS | 36 |
| | | (SEQ ID NO: 8) | |
| Extended | 0-mer | GASASEAPQNSGAPETNTEPAGSN | 41 |
| annealing | | QPAEDIAAAGSGGASAS | |
| primer | | (SEQ ID NO: 9) | |
| | 1-mer | GASASEAPQNSGAPETNTEPAGSN | 46 |
| | | QPAEDIAAAGSG(GXGGG)₁GASA | |
| | | S | |
| | | (SEQ ID NO. 10) | |
| | 1.5-mer | GASASEAPQNSGAPETNTEPAGSN | 48 |
| | | QPAEDIAAAGSG(GXGGG)₁XGGA | |
| | | SAS | |
| | | (SEQ ID NO: 11) | |
| | 2-mer | GASASEAPQNSGAPETNTEPAGSN | 51 |
| | | QPAEDIAAAGSG(GXGGG)₂GASA | |
| | | S | |
| | | (SEQ ID NO: 12) | |
| | 3-mer | GASASEAPQNSGAPETNTEPAGSN | 56 |
| | | QPAEDIAAAGSG(GXGGG)₃GASA | |
| | | S | |
| | | (SEQ ID NO: 13) | |
| | 4-mer | GASASEAPQNSGAPETNTEPAGSN | 61 |
| | | QPAEDIAAAGSG(GXGGG)₄GASA | |
| | | S | |
| | | (SEQ ID NO: 14) | |
| | 5-mer | GASASEAPQNSGAPETNTEPAGSN | 66 |
| | | QPAEDIAAAGSG(GXGGG)₅GASA | |
| | | S | |
| | | (SEQ ID NO: 15) | |

We have found that longer linkers (i.e. more than 4 repeating units in our example) are problematic when using the second PCR strategy. To overcome this and extend the length of linkers possible for larger antigens, an alternative first PCR was introduced which added an annealing sequence as before, but also extended the linker by 30 nucleotides in one example (FIG. 2f). The second PCR follows as before to add the linker library and diversity. Hence and very wide range of linker sizes can be accommodated and in this example, the linker sizes are 0 to 54 amino acids.

The PCR products from the second ligand PCRs are digested with restriction enzymes and ligated downstream (3′ to) the first ligand in the appropriate vector also digested. These ligations may be performed individually or as a pool of linker sizes. In one example, where 10 linker lengths are added of the above repeated sequence where n=1 to n−10, 10 PCR products are formed which are ligated to the first ligand and transformed into chemically or electro-competent E. coli cells (e.g. E. coli TG-1 or E. coli XL-1 blue which are suitable strains for phage display). This is plated onto bacteria media containing the appropriate antibiotic (as determined by the antibiotic resistance present in the vector of the first ligand). Many colonies are formed, usually in the range of 10⁷-10¹² per microgram of vector DNA used. This is called the linker library (FIG. 2g). The size of the library becomes more important with longer linker lengths. For example, using the ‘(Gly-Gly-Gly-Ser-X)ₙ’ (SEQ ID NO: 1) set of linkers, when n×1, the library size should be >20 to cover the 20 different permutations possible. Ideally the library size should be 10 times the possible number of permutations, so when n=1, the library size should be at least 200, n=2, the library size should be at least 4000, when n=3, the library size should be at least ×10⁴, etc. Any DNA polymerase can be used for the PCR reactions, although thermostable polymerases are preferred. High fidelity thermostable polymerases can be used which will result in clones which differ by linker length and sequence. Lower fidelity thermostable DNA polymerases can be used which may result in point mutations within the coding sequence of the ligand or linker which may lead to higher affinities not based on or adding to the chelate effect.

The linker library bacterial colonies are scrapped off the bacterial media plate and resuspended in a small volume of bacterial media containing 15% glycerol and stored at −70° C. until used. It is good practice to analyse the number of clones bearing full-length inserts using techniques such as plasmid or phagemid DNA mini-prep and restriction analysis or colony PCR and also advisory to check the DNA sequence of a number of clones to ensure that there is a diverse range of nucleotide sequence and length. Using restriction sites which closely flank the incorporated linker, one can determine the length of the linker sequence.

Skilled persons will appreciate that purification of the chelate ligand pairs, especially those consisting of antibodies or antibody fragments, can be accomplished by conventional techniques such as affinity chromatography.

The binding agent is preferably an antibody or antigen binding fragment thereof such a Fab, Fv, ScFv and dAb, but it may also be any other ligand which exhibits the preferential binding characteristic mentioned above.

Affinity chromatography is described in Scopes, R. K. (1993) Protein Purification: principles and practice 3rd Ed. Springer-Verlag, New York, ISBN 0-387-44072-3, 3-540-94072-3. (See chapters 7 and 9 in particular).

Further information on the above affinity chromatography techniques and the immunoassay of antigen and antibody is provided by Roitt (1991) Essential Immunology 7th Ed. Blackwell Scientific Publications, London, ISBN 0-632-02877-7 (see chapter 5 in particular).

The disclosure of the above references is incorporated herein by reference. Nevertheless, an the outline of known methods is described herein.

Purification of Antigens and Antibodies by Affinity Chromatography

Antigen or antibody is bound through its free amino groups to cyanogen-bromide-activated Sepharose particles. Insolubilized antibody, for example, can be used to pull the corresponding antigen out of solution in which it is present as one component of a complex mixture, by absorption to its surface. The unwanted material is washed away and the required ligand released from the affinity absorbent by disruption of the antigen antibody bonds by changing the pH or adding chaotropic ions such as thiocyanate. Likewise, an antigen immunosorbent can be used to absorb out an antibody from a mixture whence it can be purified by elution. The potentially damaging effect of the eluting agent can be avoided by running the anti-serum down an affinity column so prepared as to have relatively weak binding for the antibody being purified; under these circumstances, the antibody is retarded in flow rate rather than being firmly bound. If a protein mixture is separated by iso-electric focusing into discrete bands, an individual band can be used to affinity purify specific antibodies from a polyclonal antiserum.

Identification of Ligands by Phage Display

The display or proteins and polypeptides on the surface of bacteriophage (phage), fused to one of the phage coat proteins, provides a powerful took for the selection of specific ligands. This ‘phage display’ technique was originally used by Smith in 1985 (Science 228, 1315-7) to create large libraries of antibodies for the purpose of selecting those with high affinity for a particular antigen. More recently, the method has been employed to present peptides, domains of proteins and intact proteins at the surface of phages in order to identify ligands having desired properties.

The principles behind phage display technology are as follows;

(i) Nucleic acid encoding the protein or polypeptide for display is cloned into a phage;

(ii) The cloned nucleic acid is expressed fused to the coat-anchoring part of one of the phage coat proteins (typically the p3 or p8 coat proteins in the case of filamentous phage), such that the foreign protein or polypeptide is displayed on the surface of the phage;

(iii) The phage displaying the protein or polypeptide with the desired properties is then selected (e.g. by affinity chromatography) thereby providing a genotype (linked to a phenotype) that can be sequenced, multiplied an transferred to other expression systems.

Alternatively, the foreign protein or polypeptide may be expressed using a phagemid vector (i.e. a vector comprising origins or replication derived from a phage and a plasmid) that can be packaged as a single stranded nucleic acid in a bacteriophage coat. When phagemid vectors are employed, a “helper phage” is used to supply the functions of replication and packaging of the phagemid nucleic acid. The resulting phage will express both the wild type coat protein (encoded by the helper phage) and the modified coat protein (encoded by the phagemid), whereas only the modified coat protein is expressed when a phage vector is used.

Methods of selecting phage expressing a protein or peptide with a desired specificity are known in the art. For example, a widely used method is “panning”, in which phage stocks displaying ligands are exposed to solid phase coupled target molecules, e.g. using affinity chromatography.

Alternative methods of selecting phage of interest include SAP (Selection and Amplification of Phages; as described in WO 95/16027) and SIP (Selectively-Infective Phage; EP 614989A, WO 99/07842). which employ selection based on the amplification of phages in which the displayed ligand specifically binds to a ligand binder. In one embodiment of the SAP method, this is achieved by using non-infectious phage and connecting the ligand binder of interest to the N-terminal part of p3. Thus, if the ligand binder specifically binds to the displayed ligand, the otherwise none-infective ligand-expressing phage is provided with the parts of p3 needed for infection. Since this interaction is reversible, selection can then be based on kinetic parameters (see Duenas et al., 1996, Mol. Immunol. 33, 279-285).

The use of phage display to isolate ligands that bind biologically relevant molecules has been reviewed in Felici et al. (1995) Biotechnol. Annual Rev. 1, 149-183, Katz (1997) Annual Rev. Biophys. Biomol. Struct. 26, 27-45 and Hoogenboom et al. (1998) Immunotechnology 4(1), 1-20. Several randomised combinatorial peptide libraries have been constructed to select for polypeptides that bind different targets, e.g. cell surface receptors or DNA (reviewed by Kay, 1995, Perspect. Drug Discovery Des. 2, 251-268; Kay and Paul, 1996, Mol. Divers. 1, 139-140). Proteins and multimeric proteins have been successfully phage-displayed as functional molecules (see EP 0349578A, EP 0527839A, EP 0589877A; Chiswell and McCafferty, 1992, Trends Biotechnol. 10, 80-84). In addition, functional antibody fragments (e.g. Fab, single chain Fv [svFv]) have been expressed (McCafferty et al., 1990, Nature 348, 552-554; Barbas et al., 1991, Proc. Natl. Acad. Sci. USA 88, 7978-7982; Clackson et al., 1991, Nature 352, 624-628), and some of the shortcomings of human monoclonal antibody technology have been superseded since human high affinity antibody fragments have been isolated (Marks et al., 1991, J. Mol. Biol. 222, 581-597; Hoogenboom and Winter, 1992, J. Mol. Biol. 227, 381-388). Further information on the principles and practice of phage display is provided in Phage display of peptides and proteins: a laboratory manual Ed Kay, Winter and McCafferty (1996) Academic Press, Inc. ISBN 0-12-402380-0, the disclosure of which is incorporated herein by reference.

Accordingly, it is preferred if the linker library is cultured and manipulated so that they express the ligand on the surface of bacteriophage (or whichever display system is being used). The libraries of each linker length may be grown individually or as a pool of bacteria. In one example, the libraries are grown as a pool up to an optical density of 0.4-1.0 and super-infected with helper phage (e.g. M13-VCMS, Statagene) at a multiplicity of infection of 20:1 and continued to grow overnight with appropriate antibiotics (e.g. ampicillin and kanamycin if pHEN2 vector is used).

This procedure, known as phage rescue allows recombinant phage to be produced displaying the two ligands on the surface of the particle linked with a range of linker sequences (FIG. 2h). The recombinant phage can be used directly or purified using polyethylene glycol precipitation and/or stored in a buffer containing 15% glycerol before use. If an alternative display system is used, the appropriate procedure is employed to produce the recombinant particle displaying the two linked ligands.

In one example, the recombinant phage are used in affinity-based selection techniques to select for one or more clones which has the optimal linker (FIG. 2i). Here established affinity selection techniques can be used such as panning with antigen at low concentration, panning against biotinylated antigen followed by capture on streptavidin-coated beads, pannning on antigen fixed onto ELISA plates, off-rate selection on BIACore instruments, selection by FACS, et. If E. coli or yeast display techniques are being used, off-rate selection on the surface of these organisms can be used.

At least one round of selection may be employed. It is accepted that further rounds of selection can lead to a smaller set of clones bearing similar properties. After each round, it is advisable to monitor the progress of the selection by performing ELISA, colony PCRs/restriction digests to see if particular linker lengths are being enriched. At the end of the selection process, candidate clones are characterised by restriction digests and DNA sequencing to determine the linker length and DNA sequence.

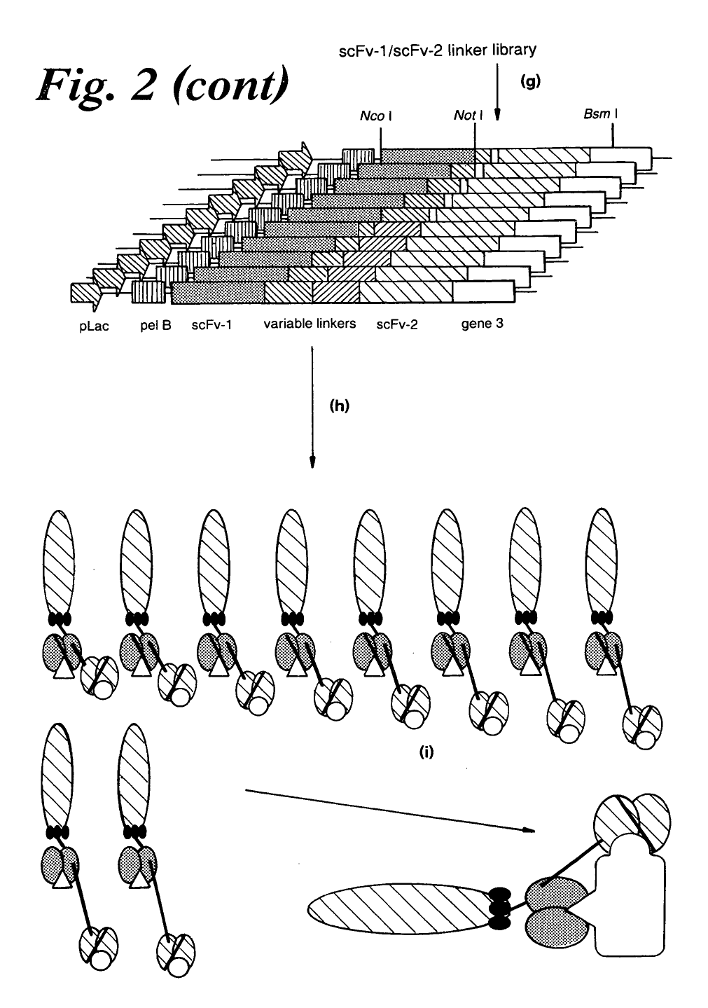

A variation on the above scheme is the use of multiple pairs of ligands. If three or more ligands are available, and it is not known if any of these bind non-overlapping epitopes, then linker libraries can be made between each pair of ligands, in either or both orientation to create a multi-CRAb (in the case of scFvs in one example) library (FIG. 3). The ones which have the highest affinity by virtue of the chelate effect and with the shortest linker in comparison to the other possible clones (as predicted in the model of Zhou [38]) will be selected in the absence of epitope binding knowledge (see example 2).

The linked ligands (chelating recombinant ligands) are expressed and purified to obtain pure protein for functional characterisation. The DNA vector they are already in can usually support expression and purification in E. coli (pLac promoter and His-6 affinity tag). If alternative systems are being used, the clones may be excised from these vectors and recloned into another vector for expression at higher levels in E. coli (e.g. a pET vector), or yeast (e.g. pPICza vectors) or mammalian cells (e.g. pCDNA3 vector). In one example where the pHEN2 vector is being used, bacterial expression is possible by transforming the clone of interest into a non-suppressor E. coli strain such as HB2151. This is followed by culturing using standard procedures (e.g. shaker flasks, 30° C. cultures in 2TY media containing ampicillin induced with 1 mM IPTG for 12-18 hrs). Proteins can be purified by IMAC by concentrating the culture supernatant for extracting the protein from the periplasmic space, followed by dialysis into PBS/1M NaCl, followed by IMAC on immobilised nickel, copper, zinc or cobalt. The final step in protein purification is usually size exclusion chromatography such as on a superdex-75 or—200 column.

The linked ligands are next tested to see if functionally they possess a higher affinity than the parental ligands. This can be done by a number of protein chemical or biophysical techniques, such as ELISA, competition ELISA, BIACore surface plasmon resonance or FACS analysis.

The linker between the two ligands serves many purposes. The primary role is to hold the two ligands in the correct spatial or topological configuration so that they may bind to their respective epitopes resulting in a high affinity chelating effect. The length of the linker will be the determining factor for this.

The sequence of the linker may also contribute by providing the correct degree of flexibility and solubility, hence the reason for incorporating one or more random residues.

Residues within the linker, due to their predicted close proximity to the surface of the bound antigen may also form interactions with the antigen which result in higher affinity, in addition to that provided by the chelate effect. The linker is essentially providing another well-positioned binding surface. Again, due to its close proximity to the surface of the antigen and being topologically distant from the antibody CDRs (or equivalent binding surface of the ligand), the linker can be used to accommodate reporter molecules such as fluorescent dyes. These reporter molecules will have different optical properties upon antigen binding and hence be invaluable as probes to detect antigen concentration.

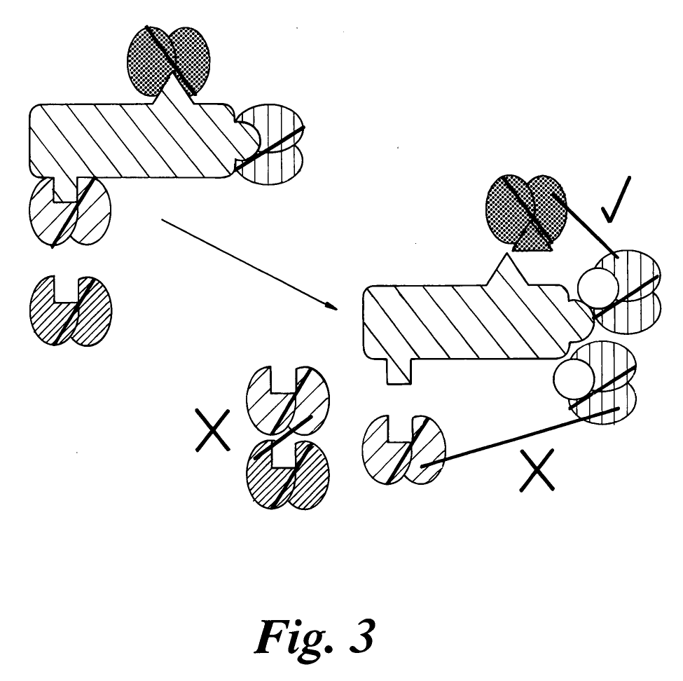

Hence, chelating ligands with a probe in the linker can make very effective biosensor proteins overcoming many of the limitations found with recombinant antibodies or other proteins (FIG. 4).

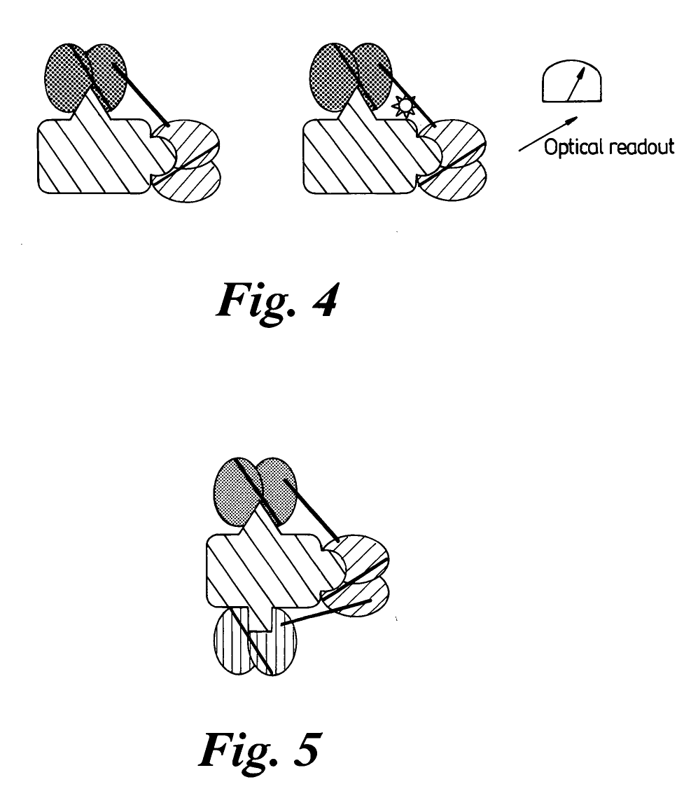

The above description applies to two ligands linked together with one linker. This invention can be extended to three or more ligands consequently with two or more linkers (FIG. 5). The same principle will apply, i.e. PCR-based construction of the linked ligands followed by affinity based selection for the highest affinity clones which has the chelate effect.

Meanings of Terms Used

‘Affinity’ is the strength of a ligand-antigen interaction normally measured by the equilibrium association/dissociation constant for the ligand-antibody complex.

“Antibody” includes antibody fragments and antigen binding molecules. These molecules include Fab-like molecules (Better et al (1998) Science 240, 1041); Fv molecules (Skerra et al (1998) Science 240, 1038); single-chain Fv (SeFv) molecules where the V_{H} and V_{L} partner domains are linked via a flexible oligopeptide (Bird et al (1998) Science 242, 423; Huston et al (1998) Proc. Natl. Acad. Sci. USA 85, 5879) and single domain antibodies (dAbs) comprising isolated V domains (Ward eat al (1989) Nature 341, 544). A general review of the techniques involved in the synthesis of antibody fragments which retain their specific biding sites is to be found in Winter & Milstein (1991) Nature 349, 293-299.

‘Antigen’ means any molecule which is recognised or bound by a ligand (e.g. protein, DNA, carbohydrate, lipid, etc).

‘Antigen barrier effect’ is a phenomenon observed in tumour targeting where very high affinity antibodies bind to the tumour cells around the tumour vasculature and do not permeate into the deeper areas of the tumour. It is proposed that the antibodies do not dissociate from the cells near the vasculature and hence cannot diffuse further inwards. The high interstitial pressure within tumuours potentiates this effect.

‘BIACore™, is the brand name for the most popular surface plasmon resonance biosensor which is used in research to study ligand-antigen interactions.

‘Biosensor’ is a molecule which can bind or interact with another molecule in such a way that a signal is generated which can report or describe the binding interaction.,

‘Biparatopic’ means a ligand which had two paratopes.

‘Chelate’ means to bind to the same target antigen or receptor molecule in such as way that two or more ligand interactions occur with the antigen or receptor, resulting in an enhanced, co-operative binding.

‘Chelating ligand pair’ means two linked ligands that take part in a chelating binding action to a target molecule. ‘Co-operative effect’ is where one action (e.g. binding) helps/favours another action (e.g. binding)

‘CRAb’ is an acronym for Chelating Recombinant Antibody, which is a pair of scFvs which bind two non-overlapping epitopes on the same antigen molecule, linked by an optimal linker to allow the chelate effect.

‘Epitope’ means specific molecular area which is recognised and bound by a ligand

‘IMAC’ is an acronym for Immobilized Metal Affinity Chromatography, a method to purify proteins carrying polyhistidine tags.

‘Library’ is a collection of clones differing in polypeptide sequence and length with potentially different properties for which they will be selected and screened against.

‘Ligand’ means a polypeptide which binds to a target antigen or receptor antigen

‘Linker’ is a polypeptide or variable length and sequence chain which connects two ligands in such as way as to alter the properties of the ligands.

‘Multi-CRAb library’ is a library of CRAbs where three or more scFvs are linked together in all possible combinations will all possible linkers.

‘null CRAb’ is a term to describe a CRAb clone which is out of the triplet reading frame with the bacteriophage gene 3 (e.g. in pHEN2). Therefore it is unable to be displayed and is useful in CRAb library construction.

‘panning’ is a term used to describe the selection process used in phage display, where the library is mixed with the target, followed by washed and recovery of bound antibodies.

‘Paratope’ means the specific polypeptide sequence of a ligand which interacts and binds to the antigen's epitope.

‘Pharmacokinetics’ is the term used to describe how a molecule behaves in a living organism in terms of tissue binding, blood levels, et.

‘Phage display’ is a technique for identifying binding ligands by displaying them on the surface of a particle such as a bacteriophage whilst the gene encoding that ligand is encoded within that particle.

‘pHEN2’ is a very commonly used DNA vector, which allows ligands such as scFvs to be displayed on the surface of bacteriophage, by fusing it to the coat protein (gene 3).

‘Receptor’ means antigen molecule which usually is involved in signalling such as a cell surface molecule.

“ScFv molecules” means molecules wherein the V_{H} and V_{L} partner domains are linked via a flexible oligopeptide.

‘size exclusion chromatography’ is a chromatographic method to separate biomolecules based on their size (molecular weight)

‘Specificity’ is that ability of a ligand to discriminate between similar antigens.

‘Xenograft’ means the grafting of foreign tissue, in this case human tumuours onto a mouse body.

### PREFERRED EMBODIMENTS

Examples embodying certain preferred aspects of the invention will now be described with reference to the following figures in which:

FIG. 1—Principle of Chelating Recombinant ligands (antibodies-CRAbs)

(a) ScFv-1 binds to epitope-1 on antigen (Moderate affinity e.g. KD=10⁻⁸ M)

(b) ScFv-2 binds to epitope-2 on antigen (Moderate affinity e.g. Kd=10⁻⁷ M)

(c) ScFv-1 (N-terminal) linked to scFv-2 (C-terminal) with a linker too short to allow an antigen chelate effect, therefore affinity is only moderately higher

(d) ScFv-1 linked to scFv-2 with a linker too long to allow an optimal antigen chelate effect, therefore affinity is only moderately higher

(e) ScFv-1 is linker to scFv-2 with optimal linker length which allows antigen chelate effect. Additional interactions could come from the linker residues. Significantly higher affinity e.g. Kd=10⁻¹⁶ M)

FIG. 2—Scheme illustrating ligand linker library construction and selection where ligand is a single-chain Fv (scFv)

(a) ScFv-1 (dark shading), derived from a cloned hybridoma or a phage library selection experiment is cloned into a vector suitable for phage display such as pHEN2. This scFv will be able to display on the surface of bacteriophage (bii)

(b) A segment of DNA sequence is cloned downstream of scFv-1 so that it is placed out of reading frame with the gene-3 phage display coat protein, meaning it will not display on the surface of bacteriophage (bi).

(c) ScFv-2 (light shading), derived from a cloned hybridoma or a phage library selection experiment is cloned into a vector suitable for phage display such as pHEN2

(d) Any restriction sites which may intefere with the cloning process is removed by silent site-directed mutagenesis (Not I in this example), followed by the first PCR (PCR-1) which amplifies the scFv with a segment of the gene-3 coat protein and incorporates a small annealing sequence (white block) at the 5′ end of the scFv-2 gene.

(e) ScFv-2 with the mutated Not I restriction site is also amplified in an alternative PCR-1 reaction to add a longer annealing sequence (thin hatched shading) which serves to make the linker longer overall.

(f) Both sets of PCR-1 reactions (long and short annealing sequence) are amplified in the second PCR reaction, PCR-2 which adds a variable length linker to the 5′ end of scFv-2 (thick hatched shading) as well as a restriction site to facilitate cloning (5′ Not I site)

(g) The scFv-2 PCR products with a range of linker sizes and sequence is digested with Not I and Bsm I and ligated at the 3′ end of the scFv-1 in pHEN also digested with Not I and Bsm I. This forms the linker library

(h) The two scFvs linked with a variable length and sequence linker are displayed on the surface of bacteriophage, by carrying out a helper phage rescue reaction.

(i) Affinity-based selection (panning) methods are used to isolate the highest affinity CRAb by virtue of it having the optimal linker (length and sequence). The gene encoding the two scFvs and the linker are simultaneously cloned during the selection process.

FIG. 3—Multiple CRAb (multi-CRAb) library

When three or more ligands (e.g. scFvs) are available, without knowing which ones bind to non-overlapping epitopes or which ones are close together, linker libraries can be made with each pair of ligands. These are pooled and selected simultaneously. Because the highest affinity clones are selected, this will yield CRAbs (marked with a tick) rather than bivalent scFvs composing of the same scFv or CRAbs of scFvs which bind to non-overlapping epitopes (marked with a cross). In addition to this, CRAbs with the shortest linker are more favoured due to the higher affinity.

FIG. 4—Chelating recombinant ligands (e.g. scFvs) can make effective biosensors

The linker between the two ligands is ideal for the covalent attachment of reporter molecules such as fluorescent probes, due to its close proximity to the antigen without being involved in binding. Hence it will not be damage the antigen-ligand interaction.

FIG. 5—Chelating recombinant ligands can be extended to three or more ligands

The same technology for biparatopic antibodies can be used to create chelating ligands with three or more ligands linked by optimal linkers.

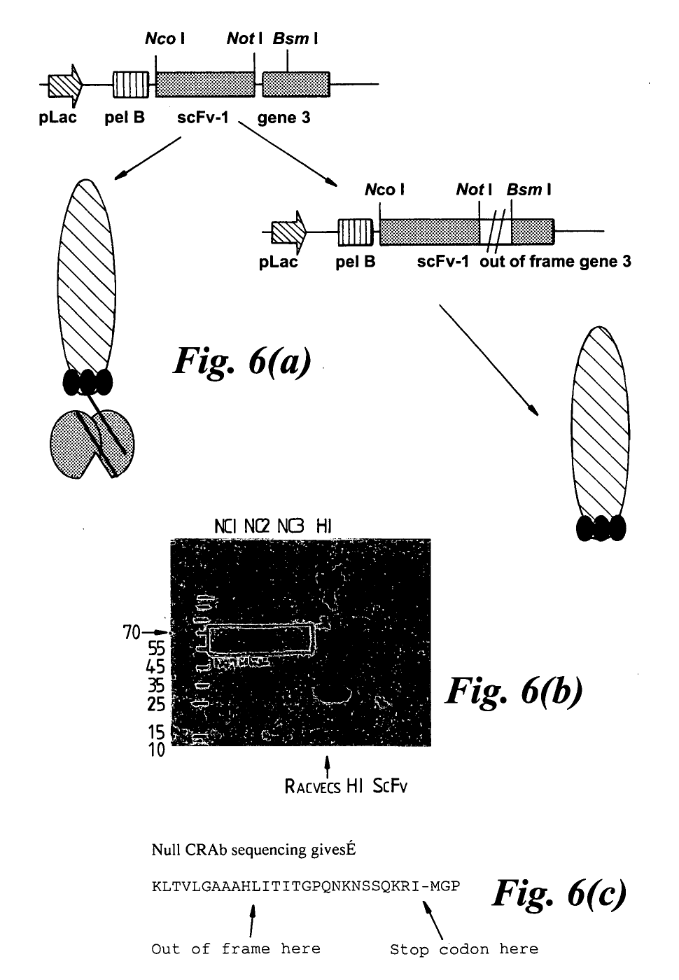

FIGS. 6a, 6b and 6c show construction of the ‘null CRAb’ and confirmation of lack of expression/display

In the scheme, ScFv-1 is converted into a non-displaying ‘null CRAb’ to that it will only form displayable CRAbs after successful library construction. This is done by cloning a piece of DNA sequence to put the scFv out of frame with the bacteriophage gene 3 and the polyhistidine tag (a). When the Null CRAb clone is expressed upon IPTG induction, the Histidine tag is not detectable, showing that the scFv is out of frame. Any sequence can be used, the one used in this example is shown in (c).

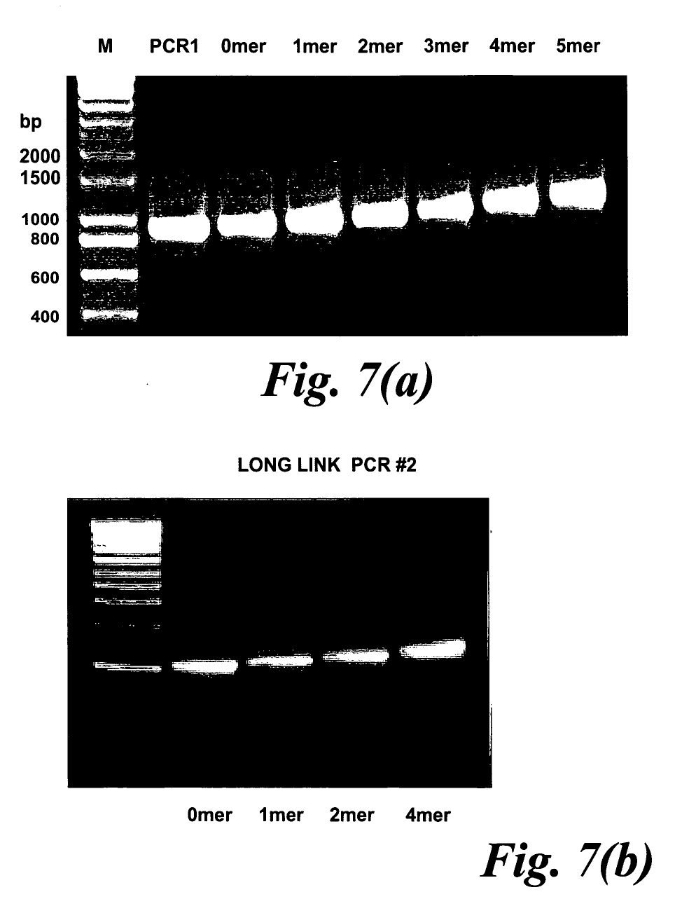

FIGS. 7a, 7b—Two-step PCR is used to incorporate linker library using standard and longer annealing sequence, PCR-1 is used to add a small annealing sequence, followed by a set of PCR reactions (a) to add linker lengths from 0-mer to 5-mer. A longer annealing sequence is also added followed by the same PCR reactions (b) as above to give 0-mer to 4-mer which are longer in length. This way, a set of linkers of variable length and sequence are constructed.

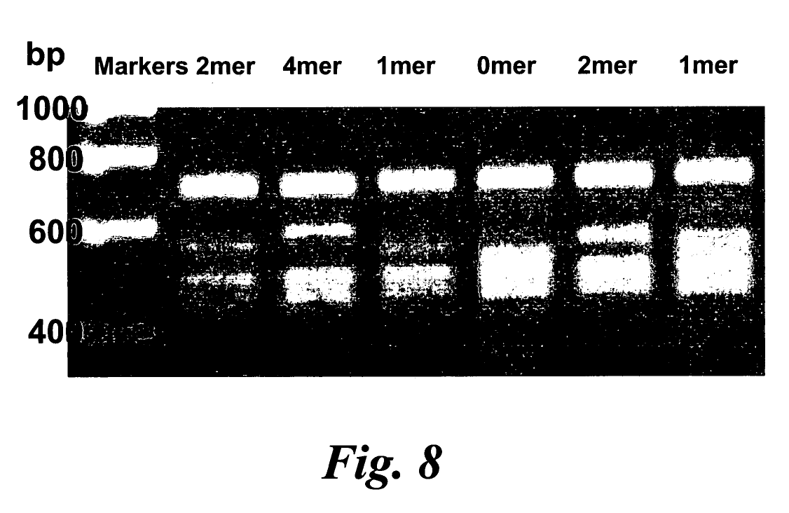

FIG. 8—Recombinant clones from the library construction were screened to show that linkers of different and variable lengths have been incorporated. Once the library has been made colonies from the ligation are checked by colony PCR and Bsm I/Not I digestion to verify that the library contains different linker sizes. In the 6 samples picked here, the second band from the top varies in size, which contains the CRAb linker.

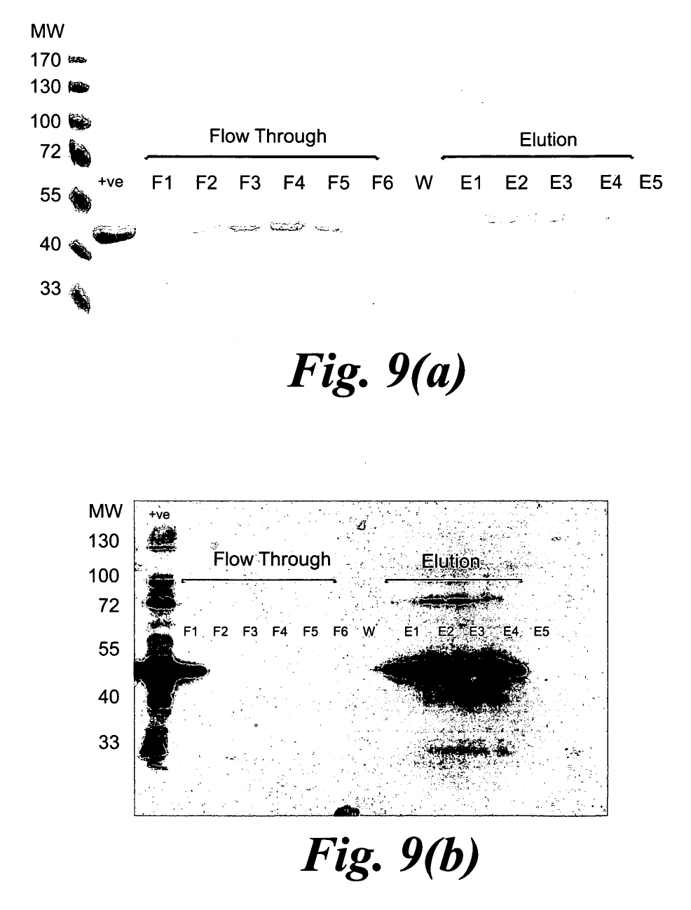

FIGS. 9a, 9b—Biotinylation and purification of lysozyme protein for selections. Lysozyme is biotinylated at a very low molar ratio and purified on soft-link agarose. The flow through contains non-biotinylated protein and the eluted fractions contain biotinylated lysozyme as confirmed by streptavidin-HRPO western blot detection.

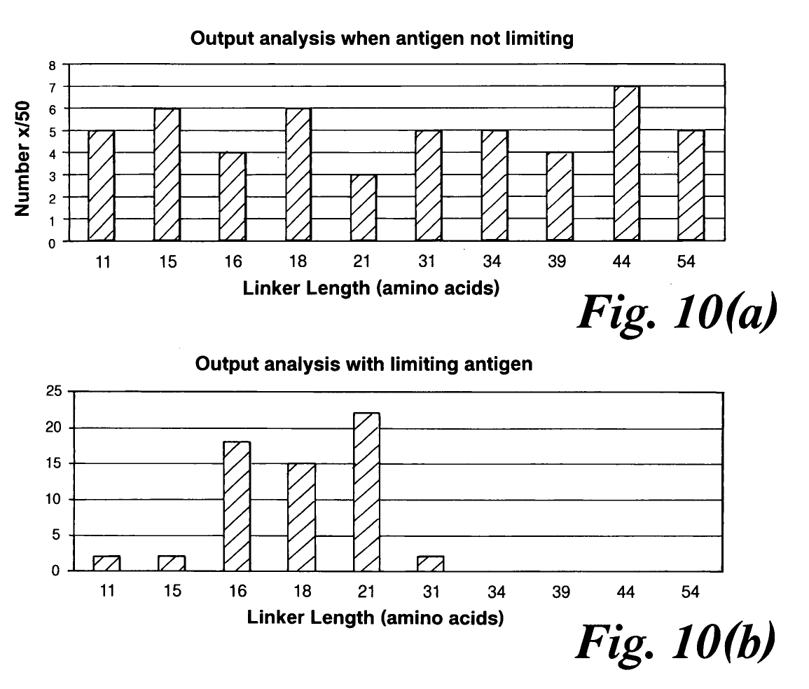

FIGS. 10a and 10b show output monitoring of full library selections against lysozyme showing enrichment for linkers predicted to be optimal.

After one round of selection with the fully-constructed anti-lysozyme CRAb library, selection results are shown. FIG. 7a shows results when antigen concentration is not limiting, CRAbs with a variety of linker lengths are selected, hence the highest affinity clones are not identified. However, then very low antigen concentrations are used, and the best binders are selected. These fall in the range of 16-21 residues. DNA sequencing (FIG. 7b) of a sample of these linkers confirm this result and show that the linker length is the key factor in giving the increased affinity, not the sequence of the linker (which is random for position ‘X’). The length selected closely agrees with the length determined by 3-D molecular modelling (18 residues, Neri et al).

| | |
|---|---|
| GSSSGSDGKASGGSASGG. | (SEQ ID NO: 16) |

After the optimised selection with limiting amounts of antigen. Five 16 amino acid linker 1-mers (16 residues)

| | |
|---|---|
| AAAGSGDGGGSGASAS | (SEQ ID NO: 17) |
| AAAGSGNGGGSGASAS | (SEQ ID NO: 18) |
| AAAGSGDGGGSGASAS | (SEQ ID NO: 17) |
| AAAGSGGGGGSGASAS | (SEQ ID NO: 19) |
| AAAGSGVGGGSGASAS | (SEQ ID NO: 20) |

Five 18 amino acid linker 1.5-mers (18 residues)

| | |
|---|---|
| AAAGSGDGGGSYGGASAS | (SEQ ID NO: 21) |
| AAAGSGAGGGSWGGASAS | (SEQ ID NO: 22) |
| AAAGSGGGGGSVGGASAS | (SEQ ID NO: 23) |
| AAAGSGSGGGSLGGASAS | (SEQ ID NO: 24) |
| AAAGSGGGGGSKGGASAS | (SEQ ID NO: 25) |

Five 21 amino acid linker 2-mers (21 residues)

| | |
|---|---|
| AAAGSGLGGGSEGGGSGASAS | (SEQ ID NO: 26) |
| AAAGSGGGGGSRGGGSGASAS | (SEQ ID NO: 27) |
| AAAGSGVGGGSQGGGSGASAS | (SEQ ID NO: 28) |
| AAAGSGAGGGSSGGGSGASAS | (SEQ ID NO: 29) |
| AAAGSGNGGGSVGGGSGASAS | (SEQ ID NO: 30) |

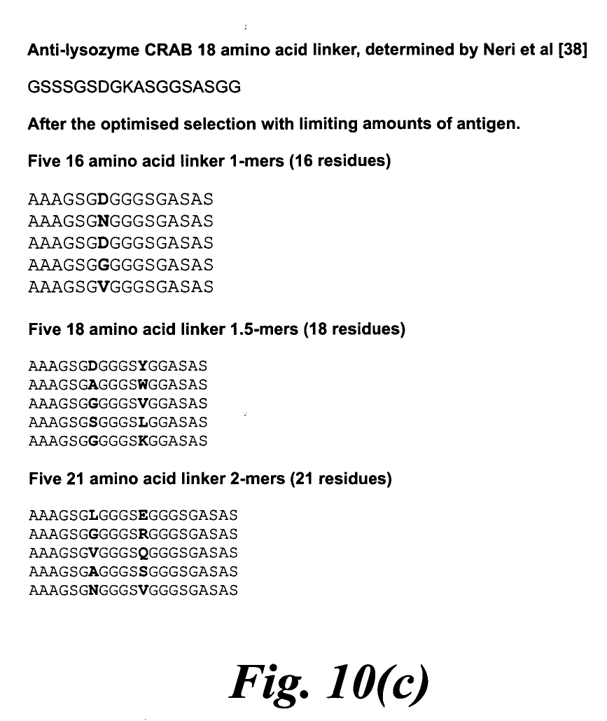

FIG. 11—A representative CRAb clone was expressed and purified by IMAC from E. coli, >90% pure CRAb protein was obtained. The arrow shows >90% pure CRAb protein. CE=Crude extract, CFT=column flow through, W1/2=washes, E1/2=elutions.

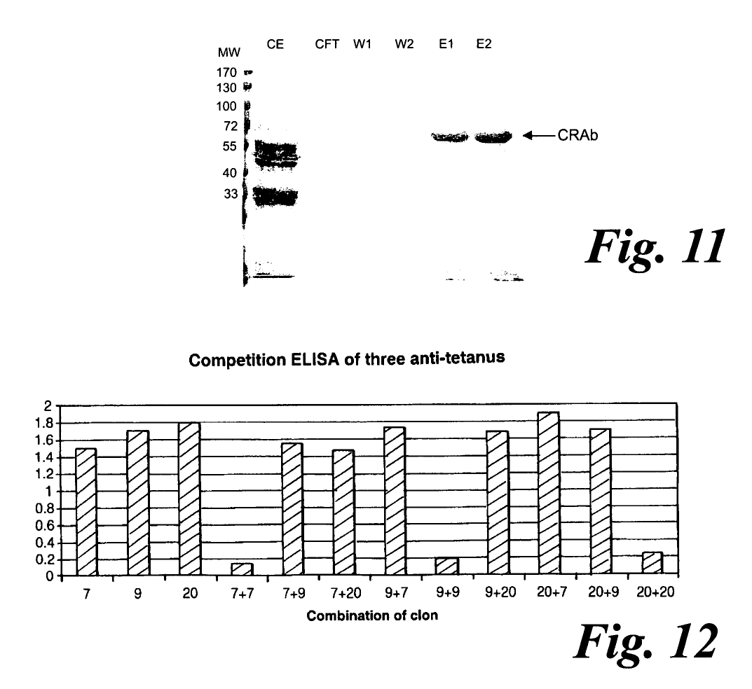

FIG. 12 is a graph of competition ELISA of three anti-tetanus toxin scFvs showing that they bind non-overlapping epitopes. Competition ELISA of three anti-tetanus toxin scFvs, clone 7/9/20 binding to immobilized tetanus toxin was performed. Phage ELISAs of each clone is shown individually, followed by the phage being competed by the scFv of each clone. It is shown that the scFv will only compete for the binding of the same phage clone, but not a different phage clone showing that all three clones bind to different, non-overlapping epitopes.

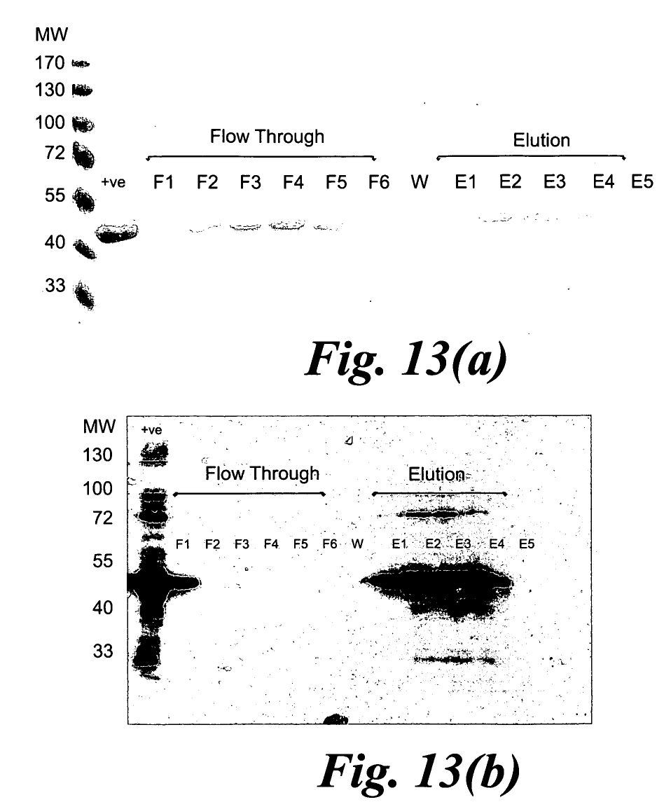

FIGS. 13a, 13b—Biotinylation and purification of tetanus toxin protein for selections

Tetanus toxin heavy chain (TeTxHc) is biotinylated at a very low molar ratio and purified on soft-link agarose. The flow through contains non-biotinylated protein and the eluted fractions contain biotinylated TeTxHc, as confirmed by streptavidin-HRPO western blot detection.

After each round of selection, individual clones can be distinguished by BamH I/Xho I restriction digests which are able to identify which parental scFv is present. Linker length can be determined by digests with Not I/Bsm I or DNA sequencing. Here, it can be seen that many different CRAb pairs are identified.

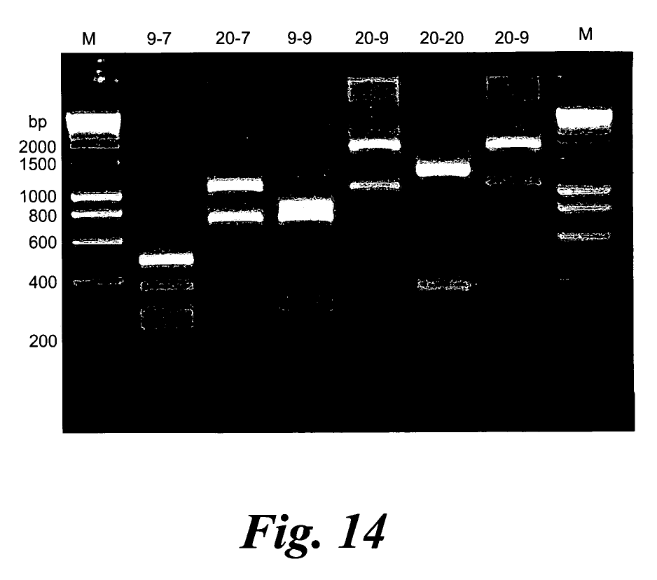

FIG. 14 is a picture of a restriction digest showing the results of output monitoring of multi-CRAb selection experiment against tetanus toxin.

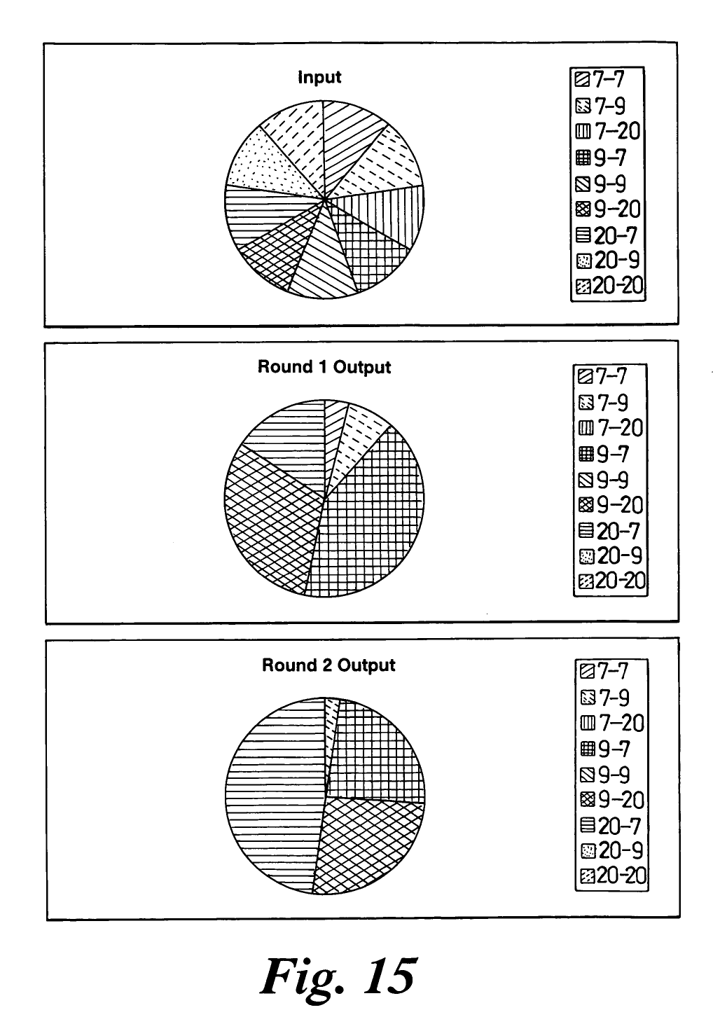

FIGS. 15a, 15b, 15c—The anti-TeTxHc multi-CRAb library contains equal numbers of each possible pair. After one round of selection, all except one out of 26 of the clones is a dimeric scFv, showing an enrichment or chelating scFvs (CRAbs). After two rounds, when 39 clones are analysed, three CRAb species predominate, with almost 50% being the 20-7 combination.

### Example 1

### Construction and Selection of an Anti-Lysozyme CRAb

Refer to FIG. 2 for the construction and selection scheme.

This example shows that the two anti-lysozyme scFvs (D1.3 and HH10TF) can be linked using our technology and obtain the correct linker size (or a range of linkers of approximately the optimal size) as already determined by the structural approach used by Neri et al and supported by the model of Zhou.

(1) A pair of anti-lysozyme scFvs who specificities are known, D1.3 [Hawkins (1993) J. Mol. Biol. 234, 958-64] and HH10TF [Lavoie (1992) J. Immunol. 148, 503-13] and known to bind to non-overlapping epitopes of the same antigen are chosen to be made into the CRAb format. The genes for these scFvs are cloned into a suitable vector for phage display such as pHEN 2, using restriction sites Nco I and Not I.

(2) The first step in the construction is the generation of a ‘null’ CRAb with the scFv destined to be the N-terminal protein (scFv-1, D1.3). This involves cloning a piece of junk DNA 3′ to this scFv, so that it will not express or display functional antibody unless in a CRAb format with anther scFv (FIG. 6). We have used an ‘out-of-frame scFv’ DNA sequence to fulfil this role.

(3). The Not I restriction site found at the 3′ end of the C-terminal scFv (scFv-2, HH10TF) is removed by silent site directed mutagenesis. This is to facilitate future cloning steps.

(4) Two PCR steps are used to firstly incorporate universal annealing sequence (or annealing/extension sequence) and secondly the linker library. The sequences of the linkers used in this linker library are described in Table 2. A range of PCR products are produced which contain HH10TF with a library of different linker lengths (FIG. 7). These linkers are based on a repeating unit of (GGGSX), (SEQ ID NO: 1) where X is any amino acid. These optimised linkers do not interfere with other sequences in the scFvs and retain flexibility and solubility.

(5) The linker library is cloned downstream (3′) of D1.3 and the ligation is plated out creating the CRAb library. Some of the clones are picked and analysed by colony PCR to show that each clone contains a full length CRAb gene and that the linker size is diverse (FIG. 8).

(6) The library is collected and phage antibodies are made by conventional phage’ rescue’. These phage represent the two scFvs, displayed on the surface of the phage particle, with a range of linker lengths separating the two scFvs.

(7) Stringent, off-rate optimised panning experiments are carried out to select the highest affinity CRAb, by virtue of the optimized chelate effect. Lysozyme is biotinylated at a very low molar ratio (ratio of 1 biotin to 20 lysozyme) to ensue that most of the biotinylated lysozyme has one biotin per molecule, Non-biotinylated lysozyme is separated from biotinylated lysozyme using a soft-link avidin column.

Three rounds of phage display and selection are carried out using decreasing concentrations of lysozyme (starting at 1 nM and lowering it to 10 pM). Linkers which are too short will not permit antigen chelation and the phage-antibodies will have lower affinities. Once the threshold has been crossed, the chelate effect comes into play and the affinity is enhanced dramatically. FIG. 10 shows the results after one round of selection indicating the linkers which are being enriched. Under conditions where thee is no selective pressure (antigen is not limiting, no linker length dominates.

However, when limiting antigen concentration is used, favouring the selection of high affinity clones, a smaller range of linker sizes are selected, with the optimal size being 16-21 residues. This length agrees well with the 18 residues predicted by Neri et al. DNA sequencing of the linker portion shows the repeating motif, with random residues in place of the ‘X.

(8) Selected clones are identified, DNA sequenced, expressed and purified as soluble protein.

### Example 2

### Construction and Selection of an Anti-Tetanus Toxin Heavy Chain (TeTxHc) CRAb from a Multi-CRAb Library

(a) Three scFvs isolated from a phage display library are chosen (Quazi, Fairweather, Wright & Deonarain, Imperial College London). Clone-7 and clone-20 are known to bind non-overlapping epitopes on the N-terminus of the toxin and clone-9 binds an epitope on the C-terminus of the toxin (from competition ELISA experiments. These have been cloned into pCANTAB-6.

(b) These three scFvs can be paired together in nine combinations (7/7, 7/9, 9/7, 7/20, 20/7, 9/9, 9/20, 20/9 and 20/20). A linker library of (GGGSX)n (SEQ ID NO: 1) where n is 0, 1, 2 and 4 is made by the two-step PCR as described above (FIG. 2d/e). These are pooled together into a mix of 9 PCR products representing the library of linkers between each of the pairs of scFvs.

(c) These PCR products are ligated (as a single pot ligation) and plated onto bacterial media. The libraries are collected, stored separately and the phage prepared as above. The phage from each linker library is grown as a pool with all the other linker libraries.

(d) Biotinylated tetanus toxin is prepared as follows. An E. coli expression vector which expresses recombinant tetanus toxin Heavy chain is transferred and grown in E. coli BL21(DE3). Recombinant protein is induced upon the addition of 1 mM IPTG for 4 hours, the cells are lysed and the protein purified by IMAC. The tetanus toxin is biotinylated at a low molar ratio and purified by soft-link avidin chromatography.

(e). The prepared phage is used in a phage display selection experiment with biotinylated TeTxHc. After one or more rounds of selection, the clones can be identified. Due to restriction site differences, it is possible to identify which pairs of scFvs have been selected and the length of the linker incorporated. Different combinations of CRAbs can be distinguished by restriction analyses.

(f) After each round of selection (two in this example), the composition of the CRAbs are analysed. The input library contains all clones in approximately equal quantity, but after the first round (FIG. 9a) and second round (FIG. 9b), particular CRAb combinations are selected. FIG. 9 shows the profile of the phage output from two round of selection. It can be seen that after two rounds of affinity selection, the species of CRAbs which are not predicted to chelate the antigen (7-7, 9-9, 16-16) have not been selected, whereas the chelating recombinant antibodies have been selected. A CRAb consisting of clone-20/7 appears to be favoured and could be due to it having the highest affinity or the shortest linker leading to more efficient chelation.

### Example 3

### Pharmaceutical Compositions and Formulations

The conjugates produced by the methods of the invention may be formulated into a pharmaceutical formulation comprising a compound according to the first aspect of the invention in admixture with a pharmaceutically or verterinarily acceptable adjuvant, diluent or carrier.

The formulation is a unit dosage containing a daily dose or unit, daily sub-dose or an appropriate fraction thereof, of the active ingredient.

The conjugates produced by the methods of the invention will normally be administered orally or by any parenteral route, in the form of a pharmaceutical formulation comprising the active ingredient, optionally in the form of a non-toxic organic, or inorganic, acid, or base, addition salt, in a pharmaceutically acceptable dosage form. Depending upon the disorder and patient to be treated, as well as the route of administration, the compositions may be administered at varying doses

In human therapy, the conjugates produced by the methods of the invention can be administered alone but will generally be administered in admixture with a suitable pharmaceutical excipient diluent or carrier selected with regard to the intended route of administration and standard pharmaceutical practice.

For example, the conjugates produced by the methods of the invention can be administered orally, buccally or sulingually in the form of tablets, capsules, ovules, elixirs, solutions or suspension, which may contain flavouring or colouring agents, for immediate-, delayed- or controlled-release applications. The compounds of invention may also be administered via intracavernosal injection.

Such tablets may contain excipients such as microcrystalline cellulose, lactose, sodium citrate, calcium carbonate, dibasic calcium phosphate and glycine, disintegrants such as starch (preferably corn, potato or tapioca starch), sodium starch glycolate, croscarmellose sodium and certain complex silicates, and granulation binders such as polyvinylpyrrolidone, hydroyporopylmethylcellulose (HPMC), hydroxy-propylcellulose (HPC), sucrose, gelatine and acacia. Additionally, lubricating agents such as magnesium stearate, stearic acid, glyceryl behenate and talc may be included.

Solid compositions of a similar type may also be employed as fillers in gelatine capsules. Preferred excipients in this regard include lactose, starch, a cellulose, milk sugar or high molecular weight polyethylene glycols. For aqueous suspensions and/or elixirs, the conjugates produced by the methods of the invention may be combined with various sweetening or flavouring agents, colouring matter or dyes, with emulsifying and/or suspending agents and with diluents such as water, ethanol, propylene glycol and glycerin, and combinations thereof.

The conjugates produced by the methods of the invention can also be administered parenterally, for example, intravenously, intra-areterially, intraperitoneally, intrathecally, intraventricularly, intrasternally, intracranially, intra-muscularly or subcutaneously, or they may be administered by infusion techniques. They are best used in the form of a sterile aqueous solution which may contain other substances, for example, enough salts or glucose to make the solution isotonic with blood. The aqueous solutions should be suitably buffered (preferably to a pH of from 3 to 9), if necessary. The preparation of suitable parenteral formulations under sterile conditions is readily accomplished by standard pharmaceutical techniques well-known to those skilled in the art.

Formulations suitable for parenteral administration include aqueous and non-aqueous sterile injection solutions which may contain anti-oxidants, buffers, bacteriostats and solutes which render the formulation isotonic with the blood of the intended recipient; and aqueous and non-aqueous sterile suspensions which may include suspending agents and thickening agents. The formulations may be presented in unit-dose or multi-dose containers, for example sealed ampoules and vials, and may be stored in a freeze-dried (lyophilised) condition requiring only the addition of the sterile liquid carrier, for example water for injections, immediately prior to use. Extemporaneous injection solutions and suspensions may be prepared from sterile powders, granules and tablets of the kind previously described.

For oral and parenteral administration to human patients, the daily dosage level of the conjugates produced by the methods will usually be from 1 mg/kg to 30 mg/kg. Thus, for example, the tablets or capsules of the compound of the invention may contain a dose of active compound for administration singly or two or more at a time, as appropriate. The physician in any event will determine the actual dosage which will be most suitable for any individual patient and it will vary with the age, weight and response of the particular patient. The above dosages are exemplary of the average case. There can, of course, be individual instances where higher or lower dosage ranges are merited and such are within the scope of this invention.

The conjugates produced by the methods of the invention can also be administered intranasally or by inhalation and are conveniently delivered in the form of a dry powder inhaler or an aerosol splay presentation from a pressurized container, pump, spray or nebuliser with the use of a suitable proplellant, e.g. dichlorodifluoromethane, trichlorofuluoromethane, dichlorotetrafluoro-ethane, a hydrofluoroalkane such as 1,1,1,2tetrafluoroethane (HFA 134A3 or 1,1,1,2,3,3,3-heptafluoropropane (HFA 227EA3), carbon dioxide or other suitable gas. In the case of a pressurised aerosol, the dosage unit may be determined by providing a valve to deliver a metered amount. The pressurised container, pump, spray or nebuliser may contain a solution or suspension of the active compound, e.g. using a mixture of ethanol and the propellant as the solvent, which may additionally contain a lubricant, e.g. sorbitan trioleate. Capsules and cartridges (made, for example, from gelatin) for use in an inhaler or insufflator may be formulated to contain a powder mix of a compound of the invention and a suitable powder base such as lactose or starch.

Aerosol or dry powder formulations are preferably arranged so that each metered dose or “puff” delivers an appropriate dose of a compound of the invention for delivery to the patient. It will be appreciated that he overall daily dose with an aerosol will vary from patient to patient, and may be administered in a single dose or, more usually, in divided doses throughout the day.

Alternatively, the conjugates produced by the methods of the invention can be administered in the form of a suppository or pessary, or they may be applied topically in the form of a lotion, solution, cream, ointment or dusting powder. The conjugates produced by the methods of the invention may also be transdermally administered, for example, by the use of a skin patch. They may also be administered by the ocular route, particularly for treating diseases of the eye.

For ophthalmic use, the conjugates produced by the methods of the invention can be formulated as micronised suspensions in isotonic, pH adjusted, sterile saline, or, preferably, as solutions in isotonic, pH adjusted, sterile saline, optionally in combination with a preservative such as a benzylalkonium chloride. Alternatively, they may be formulated in an ointment such as petrolatum.

For application topically to the skin, the conjugates produced by the methods of the invention can be formulated as a suitable ointment containing the active compound suspended or dissolved in, for example, a mixture with one or more of the following: mineral oil, liquid petrolatum, white petrolatum, propylene glycol, polyoxyethylene polyoxypropylene compound, emulsifying wax and water. Alternatively, they can be formulated as a suitable lotion or cream, suspended or dissolved in, for example, a mixture of one or more of the following: mineral oil, sorbitan monostearate, a polyethylene glycol, liquid paraffin, polysorbate 60, cetyl esters wax, cetearyl alcohol, 2-octyldodecanol, benzyl alcohol and water.

Formulations suitable for topical administration in the mouth include lozenges comprising the active ingredient in a flavoured basis, usually sucrose and acacia or tragacanth; pastilles comprising the active ingredient in an inert basis such as gelatine and glycerin, or sucrose and acacia; and mouth-washes comprising the active ingredient in a suitable liquid carrier.

Generally, in humans, oral or topical administration of the conjugates produced by the methods of the invention is the preferred route, being the most convenient. In circumstances where the recipient suffers from a swallowing disorder or from impairment of drug absorption after oral administration, the drug may be administered parenterally, e.g. sublingually or buccally.,

For veterinary use, a conjugate produced by a method of the invention is administered as a suitable acceptable formulation in accordance with normal veterinary practice and the veterinary surgeon will determine the dosing regimen and route of administration which will be most appropriate for a particular animal.

Commercial Suppliers of Reagents

The reagents used in the above examples can be obtained from many suppliers. Below we have listed preferred sources:

Restriction enzymes—New England Biolabs Ltd

DNA oligonucleotide primers—Thermo-Hybaid Ltd

Hen Egg White Lysozyme—Sigma Chemical Company

Soft-link avidin agarose—Promega Ltd

IPTG—Sigma Chemical Company

Chelating sepharose resin—Amersham Biosciences

BL21(DE3), E. coli XL1 cells—Novagen Ltd

Quick change site directed mutagenesis kit—Stratagene Ltd

Thermostable DNA polymerases and nucleotides for PCR—Promega Ltd

Helper phage for bacteriophage production—Stratagene Ltd

Long chain biotinylation reagents—Pierce Ltd

We claim:

1. A library comprising a plurality of chelating ligand pairs, each said ligand pair including two ligands capable of binding specifically to distinct epitopes on a common target molecule, wherein the two ligands of each ligand pair are joined by a linker and wherein the library comprises ligand pairs having linkers of variable length and/or variable amino acid sequence.

2. A library as claimed in claim 1 wherein one or more further ligands are optionally linked to the chelating ligand pair.

3. A library as claimed in claim 1 wherein the library is a display library.

4. A library as claimed in claim 1 wherein the library is a phage display library.

5. A library as claimed in claim 1 wherein the ligand pairs comprise a pair of antibodies or antibody fragments.

6. A library as claimed in claim 4 wherein the ligand pairs comprise a pair of scFv molecules.

7. A library as claimed in claim 1 wherein the distinct epitopes do not overlap.

8. A library as claimed in claim 1 wherein a further molecule is attached to the chelating ligand pair further comprises a detectable or therapeutically active moiety.

9. A library as claimed in claim 8 wherein the further moiety is selected form detection tags (e.g. polyhistidine, c-myc), tags for further interactions such as biotin), radioisotopes for diagnosis and therapy (e.g. Iodine-125, Yttrium-90, Technicium-99), enzymes (e.g. drug activating enxymes-carboxypeptidase G2, beta lactamase), toxins (e.g. ricin), drugs (e.g. methotrexate and taxol), photosensitisers (e.g. foscan) and cytokines (e.g. IL-2, IL-12, IL-15).

10. A library as claimed in claim 8 wherein one or more properties of the further moiety are altered when the chelating ligand pair is bound to the target molecule.

11. A method of making a library of chelating ligand pairs as defined in claim 1 comprising the steps of;
(a) providing a plurality of first ligands;
(b) providing a plurality of second ligands, said second ligand being attached to a linker molecule, and wherein the linker molecules are of variable length and variable amino acid composition;
(c) joining a first ligand to a second ligand using the linker so as to form a plurality of chelating ligand pairs; and
(d) repeating step (c) so as to produce a library of chelating ligand pairs.

12. A method as claimed in claim 11 whrein the first ligands provided in step (a) are modified to disrupt the C-terminal sequence to prevent display of the first ligand.

13. A method as claimed in claim 11 wherein the modification to the C-terminal sequence preventing display is corrected when the first ligand is joined to the second ligand.

14. A method as claimed in claim 11 wherein the method includes the optional step of:
(c) displaying the library of chelating ligand pairs.

15. A method as claimed in claim 11 wherein the method includes the further optional step of:
(f) exposing the library to the target molecule.

16. A method as claimed in claim 15 wherein the method includes the further optional step of:
(g) identifying the chelating ligand pair exhibiting the desired binding activity;
(h) isolating the chelating ligand pair exhibiting the desired binding activity;
(i) amplifying the chelating ligand pair isolated in step (h);
(j) formulating the chelating ligand pair isolated in step (h) and/or amplified in step (i) into a pharmaceutical composition.

17. A method as claimed in claim 16 wherein the desired binding activity is represented by the ligand pair exhibiting the strongest binding affinity.

18. A method of use of a library as defined in claim 1 to identify chelating ligand pairs exhibiting a desired binding activity.

19. The method as defined in claim 11 in identifying chelating pairs exhibiting a desired binding activity.
